(19) United States
(12) Patent Application Publication
(10) Pub. No.: US 2025/0017134 A1
(43) Pub. Date: Jan. 16, 2025

(54) SEED METERING DEVICE

(71) Applicant: Deere & Company, Moline, IL (US)

(72) Inventors: Lee E. Zumdome, Bettendorf, IA (US); Elijah B. Garner, Bettendorf, IA (US); Douglas J. Olson, Valley City, ND (US)

(73) Assignee: Deere & Company, Moline, IL (US)

(21) Appl. No.: 18/901,993

(22) Filed: Sep. 30, 2024

Related U.S. Application Data
(63) Continuation of application No. PCT/US2023/017206, filed on Mar. 31, 2023.
(60) Provisional application No. 63/326,590, filed on Apr. 1, 2022.

(51) Int. Cl. A01C 7/04; A01C 7/10

(52) U.S. Cl. CPC A01C 7/0443; A01C 7/046; A01C 7/105

(57) ABSTRACT

One or more techniques and/or systems are disclosed for seed metering for an agricultural seeder. The seed metering includes a metering member for an agricultural implement having a body configured to couple with a metering device and a raised ring formed circumferentially around a rim of the body. The raised ring defines a plurality of seed receiving portions each configured to receive a seed therein, wherein the plurality of seed receiving portions have a plurality of walls defining a continuous wall structure and forming a cavity therein. The cavity has an outwardly facing open end and one or more walls of the plurality of walls have a different height than one or more other walls within each seed receiving portion.

### CROSS-REFERENCE TO RELATED APPLICATIONS

This application is a U.S. by-pass continuation application of International Application No. PCT/US2023/017206, filed Mar. 31, 2023, which claims the benefit of and priority to U.S. Provisional Application No. 63/326,590, filed Apr. 1, 2022, entitled SEED METERING DEVICE. The entireties if the aforementioned applications are incorporated by reference herein.

### BACKGROUND

Agricultural planters and seeders, and other seeding work vehicles/devices, are configured for applying seed, fertilizer, and/or other particulate commodities to a field. Planters typically include one or more containers and a metering system having a seed meter that meters out a specific population of seed as the work vehicle moves across the field. Seed meters facilitate mechanized planting of seeds with increased efficiency by taking seeds from a seed pool within the seed meter and sequentially discharging individual seeds for sowing in the field. In these seed meters, if seeds are not singled out, multiple seeds are planted together, or skips are present in the field where there should have been seeds placed. Both of these situations is not desirable.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for seed metering having improved singulation properties. In one implementation, a metering member for an agricultural implement comprises a body configured to couple with a metering device and a raised ring formed circumferentially around a rim of the body. The raised ring defines a plurality of seed receiving portions each configured to receive a seed therein, wherein the plurality of seed receiving portions have a plurality of walls defining a continuous wall structure and forming a cavity therein. In this implementation the cavity has an outwardly facing open end and one or more walls of the plurality of walls have a different height than one or more other walls within each seed receiving portion.

In another implementation, a metering member for an agricultural implement comprises a body configured to couple with a metering device and a plurality of protruding structures extending from the body. The plurality of protruding structures define spaced apart seed receiving portions (e.g., seed-shaped cells) therebetween and are configured to receive seeds therein. Each of the seed receiving portions have a plurality of walls with different heights and at least one wall of the plurality of walls is an arcuate wall having a configuration complementary to a seed shape.

In another implementation, a system for planting seeds comprises a metering member that receives seeds, at a seed meter input, from a seed source, and rotates to provide the seeds at a seed meter output. The system further comprises a seed meter motor that drives rotation of the metering member and a seed delivery system that receives the seeds, from the seed meter output, and outputs the seeds at an outlet end of the seed delivery system, into a furrow. The system also comprises a motor control system that is configured to generate a motor control signal to control the seed meter motor to change a motor speed of the seed meter motor to selectively provide hilldrop seed groupings or singulated seeds.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a perspective view of an agricultural seeding machine in which various examples can be implemented.

FIG. 2 is a component diagram of an agricultural seeding machine in which various examples can be implemented.

FIG. 3 is a perspective view of a portion of a metering member according to one implementation.

FIG. 4 is a different perspective view of a portion of a metering member according to another implementation.

FIG. 5 is a perspective view of a seed receiving portion of a metering member according to an implementation.

FIG. 6 is another perspective view of seed receiving portions of a metering member according to an implementation.

FIG. 7 is yet another perspective view of seed receiving portions of a metering member according to an implementation.

FIG. 8 is a top perspective view of seed receiving portions of a metering member according to an implementation showing a seed within one of the seed receiving portions.

FIG. 9 is a perspective view of a seed meter showing internal components according to an implementation.

FIG. 10 is a perspective view of a seed meter with an open cover showing a metering member according to an implementation.

FIG. 11 is a diagram illustrating an active seed delivery system that can be used with a seed metering system according to an implementation.

FIG. 12 is a diagram of an active and delivery system that can be used with a seed metering system according to another implementation.

FIG. 13 is a block diagram showing a motor control system architecture according to an implementation.

FIG. 14 is a perspective view of a metering member according to another implementation.

FIG. 15 is a another perspective view of the metering member of FIG. 14.

FIG. 16 is a another perspective view of the metering member of FIG. 14.

FIG. 17 shows one example of grouped seeds metered according to an implementation.

FIG. 18 illustrates an example of a method for controlling seeding operation according to one implementation.

FIGS. 19-54 illustrate metering members according to various implementations.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, may be suitable for use in different seed metering and delivery applications. That is, the herein disclosed examples can be implemented in different seeders other than for particular types of seeds and/or delivery systems, such as other than for specific farm seeder vehicles for particular seeding applications.

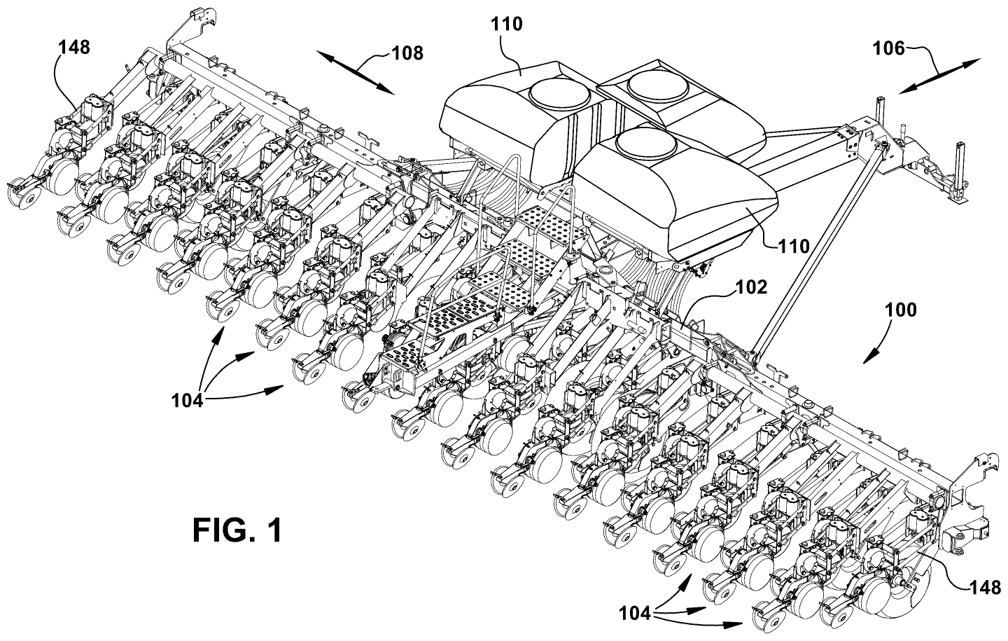

FIG. 1 is a component diagram illustrating an example implementation of a system that may utilize one or more portions of the aspects and examples described herein. In the implementation illustrated in FIG. 1, a vehicle, shown as an agricultural seeding machine 100 includes a frame 102 on which are mounted a plurality of individual planting units 104. The agricultural seeding machine 100 in some examples has a fore-aft direction shown by the arrow 106 and a transverse direction shown by the arrow 108. Each planting unit 104 is coupled to the frame 102 by a parallel linkage 148 so that the individual planting units 104 can move up and down to a limited degree relative to the frame 102. A plurality of storage tanks 110 (e.g., commodity containers) hold commodity such as seed or fertilizer that is delivered pneumatically to a mini-hopper on each planting unit 104 in various examples. In some examples, the planting units 104 define one or more planting machines.

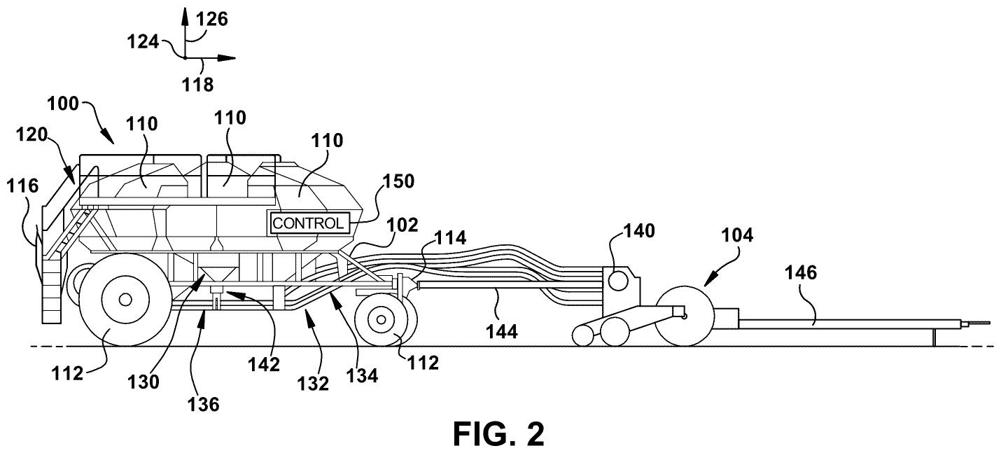

Each planting unit 104 is configured to form an open furrow in the soil beneath the seeding machine into which seed is deposited. Other components, such as closing and packing wheels are also mounted to and form part of the planting units 104 to close the furrow over the deposited seed and to firm the soil in the closed furrow. In one particular implementation as shown in FIG. 2, the agricultural seeding machine 100 includes the frame 102 (e.g., chassis) movable with a plurality of wheels 112. The frame 102 can be assembled from rigid beams, bars, brackets, or other structures and may support the components as disclosed herein. The wheels 112 support the frame 102 on terrain and enable movement of the agricultural seeding machine 100 across the terrain. As shown, the frame 102 extends between a front end 114 (e.g., first end) and a rear end 116 (e.g., second end) of the agricultural seeding machine 100. A tow bar 146 extend from the frame 102 at the front end 114 for attaching the agricultural seeding machine 100 to the row of planting units 104.

As can be seen, the storage tanks 110 are supported on the frame 102. The storage tanks 110 contain seed, fertilizer, and/or another particulate or granular commodity. Additionally, in some examples, the storage tanks 110 include a liquid commodity. There may be any number of storage tanks 110 (e.g., four storage tanks).

Additionally, the agricultural seeding machine 100 further includes at least one metering system 130. The metering system 130 in some examples is a volumetric metering system. The metering system 130 is configured to receive commodity from the storage tanks 110 and meter commodity to a downstream component using one or more examples (e.g., to a metering member as described in more detail herein). In some examples, the metering system 130 is supported by the frame 102 and is disposed generally underneath the storage tanks 110. The metering system 130 in various examples includes a plurality of metering roller assemblies (e.g., knob, element, shaft, and coupler) that actuate (e.g., rotate) to meter out the commodity from the storage tanks 110. During operation, particles of the commodity within one of the storage tanks 110 moves vertically downward toward the metering system 130. The metering system 130 operates to meter out the commodity from the storage tanks 110 at a predetermined, controlled rate as the agricultural seeding machine 100 moves across the field.

The agricultural seeding machine 100 also includes a delivery system 132. The delivery system 132 include at least one delivery run 134. The delivery run(s) 134 define a fluid pathway for delivery of the commodity away from the agricultural seeding machine 100. In some examples, the plurality of the runs 134 include a respective run structure 136 (e.g., a primary tube or pipe) that is supported below the metering system 130. The run structures 136 in some examples are rigid pipe segments that are fixed to the frame 102. The run structures 136 are in fluid communication with downstream components (e.g., downstream pipe segments in the respective run 134, downstream manifolds, and/or rows of planting units 104).

For example, the runs 134 conduct a flow of air from the rear end 116 to the front end 114 and away from the agricultural seeding machine 100. Airflow within the runs 134 in some examples is generated by one or more fan(s) or other source(s) 120 mounted on the rear end 116 of the agricultural seeding machine 100. The one or more fan(s) or other source(s) 120 provide one or more source(s) of flowing fluid(s) at one or more different pressure(s) as may be necessary and/or desired to carry the one or more different commodities to the rows of planting units 104. In some examples, a first run structure defines a first run passage configured to receive an associated first fluid flowing from an associated first source 120 at a first pressure, a second run structure defines a second run passage configured to receive an associated second fluid flowing from an associated second source 120 at a second pressure, a third run structure defines a third run passage configured to receive an associated third fluid flowing from an associated third source 120 at a third pressure, etc.

The runs 134 are operably connected with the metering system 130 such that particles of the commodity (e.g., seeds) metered out by the metering system 130 are received by selected ones of the runs 134. In some examples, the particles move substantially vertically downward into the selected runs 134. Once in the runs 134, the air stream therein propels the metered particles away from the agricultural seeding machine 100 and toward the rows of planting units 104.

In some examples, at least one of the runs 134 of the delivery system 132 are operably connected with a downstream metering system 140 that provides improved metering as described in more detail herein. As shown in FIG. 2, the downstream metering system 140 may be supported by the rows of planting units 104. It should be appreciated that a plurality of rows of planting units 104 can include respective downstream metering systems 140. Additionally, in some examples, some rows of planting units 104 include a respective downstream metering system 140 and others may not. In some examples, the downstream metering system 140 is configured as a singulating metering system that receives commodity via one of the runs 134 and that meters out singulated particles of the commodity therefrom for planting as described in more detail herein.

Furthermore, the delivery system 132 include at least one manifold regulator 142. The manifold regulator 142 is supported by the frame 102 in some examples. The manifold regulator 142 is operably disposed between the metering system 130 and two or more of the run structures 136, and between the pressure sources 120 and the storage tanks 110. In some implementations, the manifold regulator 142 is configured for selectively changing the pathway for the commodity from a first storage tank 110 through a selected one of the delivery runs 134 by movement of a valve member relative to a body member of a commodity valve, and simultaneously also for automatically delivering pressure to the first storage tank 110 supplying the commodity in accordance with the selected delivery run pathway selected. For example, the manifold regulator 142 can be manually or automatically moved to select a first position of the valve member relative to the body in which commodity metered from the metering system 130 is payed out from a first storage tank 110 to a first one of the runs 134 for delivery to a respective row of planting units 104. The manifold regulator 142 can further be manually or automatically moved to select a second position of the valve member relative to the body in which commodity metered from the metering system 130 is metered out from the first storage tank 110 to a second one of the runs 134 for delivery to a different row of planting units 104.

In operation, the a agricultural seeding machine 100 according to the illustrated example is configured to be towed by another vehicle, such as a tractor (not shown). In other examples, the agricultural seeding machine 100 is be a self-propelled vehicle. In some examples, the agricultural seeding machine 100 is an air cart or air drill that contains a bulk amount of a commodity, which meters out the commodity from the bulk amount, and moves the metered commodity away from the agricultural seeding machine 100 for planting in the ground. In some examples, the commodity delivered from the agricultural seeding machine 100 is metered further downstream before being planted using one or more seed metering configurations. The agricultural seeding machine 100 is merely an example where one or more portions of various examples may be implemented. One or more features of the various examples may be included on a different work vehicle, such as a planter, a commodity cart, or other work vehicle without departing from the scope of the present disclosure.

It should be noted that in the illustrated example, a longitudinal axis 118 (e.g., primary axis) is indicated for reference purposes. The longitudinal axis 118 may be substantially parallel to a direction of travel of the agricultural seeding machine 100. Thus, the longitudinal axis 118 may be parallel to the fore-aft axis of the agricultural seeding machine 100. A lateral axis 124 is also indicated in FIG. 2. The lateral axis 124 is perpendicular to the longitudinal axis 118 and extends between opposite lateral sides of the agricultural seeding machine 100. Furthermore, a vertical axis 126 is indicated in FIG. 2 for reference purposes. In some examples, a control unit 150 can be used to control operations of one or more portions of the agricultural seeding machine 100. For example, the control unit 150 comprises one or more microprocessors that utilize commands and/or programs to operate the example agricultural seeding machine 100.

In some examples, the agricultural seeding machine 100 is configured for delivering the commodity to the one or more rows of planting units 104. Each row unit of the rows of planting units 104, thus, includes features for respectively tilling the soil, opening a furrow in the soil, depositing the commodity into the furrow, and closing the furrow. In some examples, the rows of planting units 104 are connected together and arranged in series along the lateral axis 124. It should be noted that although only one row of planting units 104 is shown in FIG. 2, it should be appreciated that similar rows of planting units 104 can be included and disposed in series along the lateral axis 124. The rows of planting units 104 are connected with the agricultural seeding machine 100 via a rear tow bar 144. The rows of planting units 104 are also connected with the towing vehicle (e.g., tractor) via the forward tow bar 146. Accordingly, the rows of planting units 104 are disposed between the agricultural seeding machine 100 and the towing vehicle with respect to the longitudinal axis 118 in various examples. However, the rows of planting units 104 can be disposed behind the agricultural seeding machine 100 in some examples and/or the rows of planting units 104 can be directly connected with the agricultural seeding machine 100 (e.g., directly connected with the frame of the agricultural seeding machine 100) without departing from the scope of the present disclosure.

Various examples of metering configurations will now be described. The metering configurations operably rotate to meter out a commodity (e.g., seed, fertilizer, other granular or pelletized products), particularly singulate commodity for planting. It should be noted that in some examples, different metering configurations are provided based on the type and/or size of the commodity (e.g., seed) to be dispensed. That is, the one or more elements or features of the metering configurations can be changed based on the particular commodity to be dispensed.

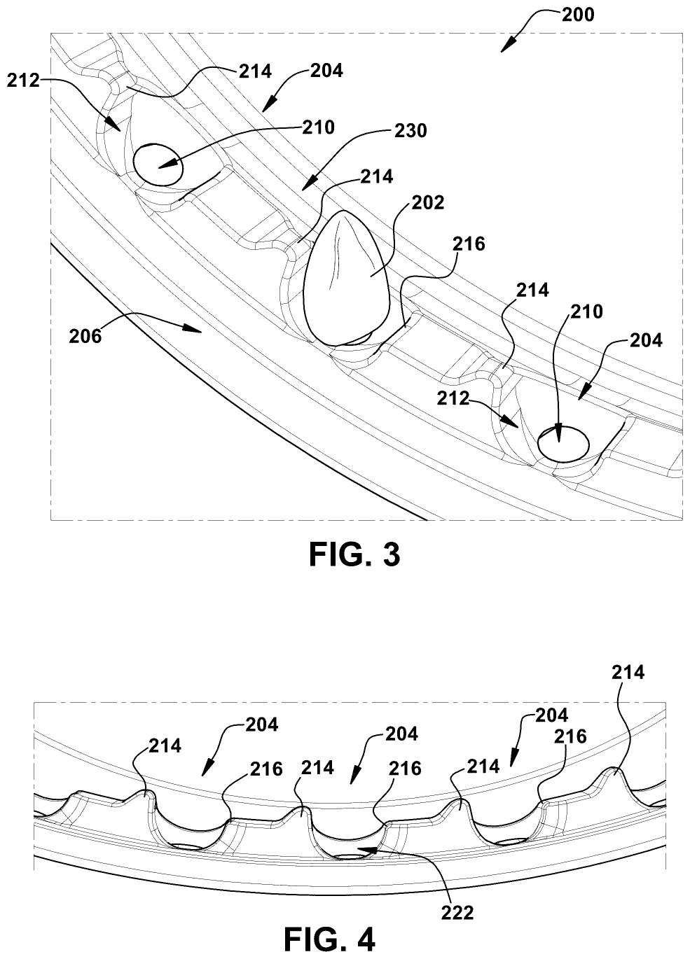

One metering configuration is illustrated in FIG. 3, showing a portion of a metering member 200 configured to meter commodity, which in this example is seed 202 (illustrated as corn). That is, the metering member 200 is configured to singulate the seed 202 for dispensing, such as with the agricultural seeding machine 100 described in more detail herein. It should be noted that the metering member 200 can be configured to operate with different types of metering and/or delivery system and can form part of differently configured metering devices. In some examples, the metering member 200 is configured as a bowl-shaped metering member. In other examples, the metering member 200 is configured as a disc-shaped metering member. In the various examples, the metering member 200 is generally configured having a cell-type geometry, such as for use with the ExactEmerge Seed Meter and Delivery Cartridge system available from John Deere.

In various examples, the metering member 200 includes a plurality of seed receiving portions 204 configured as individual cells separated by a distance along a rim 206 of a body 208 of the metering member 200. That is, the plurality of seed receiving portions 204 are spaced apart circumferentially along the rim 206 to form a raised ring 230 that provides singulation of seeds to be dispensed. In various examples, the spacing between each seed receiving portion 204 is based on the type and/or size of the seeds 202 to be dispensed. The features of the plurality of seed receiving portions 204 are also varied in some examples based on the type and/or size of the seeds 202 to be dispensed.

In in illustrated example, the plurality of seed receiving portions 204 are configured having a ‘cup-like’ feature geometry defining a cavity 212 that includes a seed hole 210 at a bottom of each of the seed receiving portions 204. As can be seen, the cavity 212 has a seed-shaped configuration or profile. In various examples, the seed hole 210 is an opening through the body 208 and the ‘cup-like’ feature geometry helps generate an improved singulation and vacuum seal between the seed 202 and the seed hole 210 (e.g., vacuum/pressurized hole) on the body 208 (e.g., through the seed disk or seed bowl). In some examples, the ‘cup-like’ feature results in reducing the stacking of multiple seeds on the seed hole 210. That is, the ‘cup-like’ feature and configuration of the seed receiving portions 204 reduces the likelihood that multiple seeds 202 are held within the seed receiving portions 204 and thereafter dispensed. For example, in disk type configurations that use a paddle geometry on the disk, which is needed to load the seed 202 into a seed delivery belt (now shown), the ability to singulate seed (removal of multiple seeds stacked up that are protected by the paddle from the) is reduced. This cell geometry having the ‘cup-like’ feature allows for the use of different types of delivery systems (e.g., a doubles eliminator) on, for example, flat disc type configurations (e.g., on a cell geometry on flat ME5 style disks). As described in more detail herein, the cell-type geometry having the ‘cup-like’ feature couples with an integrated paddle feature for loading seeding into, for example, an endless delivery conveyance belt (brush). In various examples, this configuration results in improved seed singulation, while maintaining the same ability to load seed into the delivery system.

The seed receiving portions 204 in some examples are formed as a protruding structures and/or a raised ring defining the metering member 200 along the rim 206 of the body 208. That is, the seed receiving portions 204 define an array of the cavities 212 along the rim 206, which in some examples extend between inner and outer surfaces of a side wall of a metering device as described in more detail herein.

Thus, in various examples, a series of raised features or projections are provided and form the ring-geometry as described in more detail herein. In particular, the seed receiving portions 204 define raised portions (e.g., protrusions) that have a gap therebetween to allow singulation to occur and is compatible with different singulating devices. That is, the gap is configured to facilitate single seed support and transfer using the seed receiving portions 204 having cavities 212 formed as cells (within the gaps) that are complementary to the shape of the seeds 202. In the various examples, the cavities 212 are sized and shaped to receive and maintain a single seed 202 therein for delivery. The cavities 212 are not recesses within the body 208 in various examples, but instead define seed-shaped pockets in the gaps between raised portions as described in more detail herein. That is, various examples provide a raised ring around the metering member 200, for example, a raised ring with inset cells defined by the cavities 212. In some examples, the projections or other protruding structures are provided in-between cells to define the cavities 212, wherein the projections or other protruding structures have particular characteristics as described in more detail herein.

More particularly, in various examples, the seed receiving portions 204 include the cavities 212 that have a rear wall 214, a front wall 216, and a side wall 218 that together partially enclose and form the cavity 212. That is, the rear wall 214, the front wall 216, and the side wall 218 in some examples form a continuous wall structure to define the cavity 212 that has an open end 222 along the rim 206, namely an outwardly facing opening as viewed in the figures (e.g., radially outwardly facing), and an open top. The rear wall 214, the front wall 216, and the side wall 218 are configured to facilitate singulated seed loading and transfer in a singulating process as described in more detail herein. In some examples, the rear wall 214, the front wall 216, and the side wall 218 are integrally formed with the body 208 to define a unitary construction or design of the metering member 200.

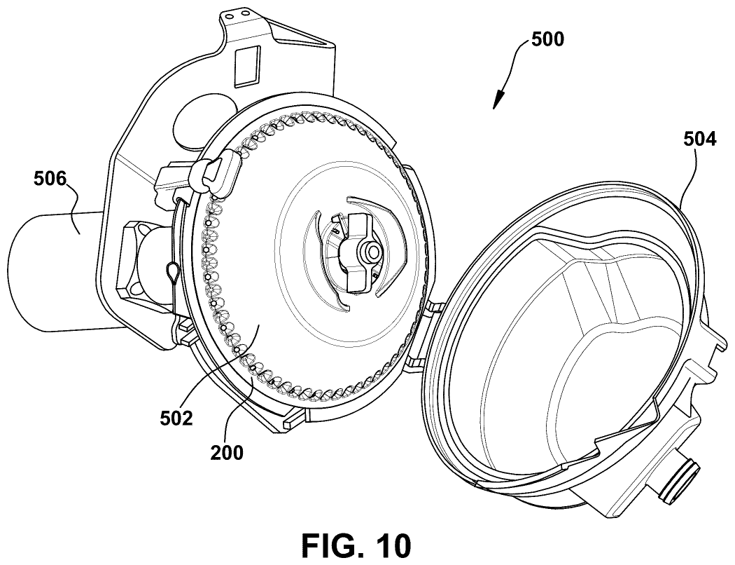

The rear wall 214 in various examples has a height greater than each of the front wall 216 and the side wall 218. That is, the rear wall 214 has a raised wall that extends higher vertically than a top of each of the front wall 216 and the side wall 218. The rear wall 214 in some examples is a trailing wall that trails the front wall 216 (i.e., is behind the front wall 216) along a direction of travel of the seed receiving portions 204 (e.g., a direction of rotation of the metering member 200). In one configuration, the rear wall 214 is a ‘paddle’ or loading member that facilitates loading the seed into a brush belt as described in more herein. That is, the rear wall 214 trails behind the front wall 216 during operation of the metering member 200, namely rotation of the metering member 200, to facilitate receiving the seed 202 into the cavity 212 and releasing the seed 202 to thereafter be delivered for planting. That is, the rear wall 214 defines a tall portion of the cavity 212 that is configured to facilitate “pulling” the seed 202 out of the cavity 212 (e.g., the height is based on a brushing motion or requirement of one or more brushes (seed brushes) configured to brush the seed 202 out of the cavity 212). The rear wall 214 is, thus, a structure that extends from the inner surface of the side wall 218 and located behind each “aperture” with respect to a direction of rotation 414 (see FIG. 10) of the metering member 200. As such, the structure of the rear wall 214 forms a confronting surface behind the associated “aperture” in the direction of rotation 414 to push the seed 202 adhered within the seed hole 210 into a delivery system (not shown) for delivering the seed 202 from the metering member 200 to the ground for planting.

In the illustrated example, the front wall 216, being vertically lower in height than the rear wall 214, and being a leading wall, facilitates loading of the seed 202 into the cavity 212. For example, the lower height of the front wall 216 allows the seed to be loaded into the cavity 212 and blocked or stopped from further movement (e.g., stopped from further rearward movement) by the rear wall 214, as well as from vacuum pressure applied to the seed hole 210. As such, in operation, the front wall 216 facilitates movement of the seed 202 into the cavity 212, namely into the orifice defined by the cavity 212. It should be noted that the difference in height between the front wall 216 (and the side wall 218) and the rear wall 214 can be varied as desired or needed. For example, the difference in height between one or more of the rear wall 214, the front wall 216, and the side wall 218 can be selected based on the type and/or size of the seeds 202, the type and/or configuration of the singulator, the type and/or configuration of the delivery system, etc.

The side wall 218 in various examples has an arcuate shape to be complementary to the shape or profile of the seed 202 to be held within the cavity 212 (whereas the rear wall 214 and the front wall 216 are generally planar). The side wall 218 further facilitates loading of a single seed 202 within the cavity 212 and supporting the seed 202 within the cavity 212. That is, the side wall 218 is shaped and sized to “cup” a single seed within the cavity 212. In one example, the cavity 212 is sized to be about ten millimeters (10 mm) across from the rear wall 214 to the front wall 216 to “cup” the single seed. However, other sized cavities 212 are contemplated, such as based on the type and/or size of the seed 202. For example, in various examples, the cavity 212 and/or other portions or features of the metering member 200 have dimensional differences based on the type and/or size of the seed 202 to be metered. It should be noted that although one or more examples as illustrated herein can be used for metering corn or sunflower seeds, the herein described configurations can be implemented to meter other types of seeds. For example, one or more configurations described herein can be implemented to meter cotton seeds, large edible beans, etc.

Thus, the side wall 218 in the illustrated examples has a vertical height similar to the front wall 216, which is lower than the rear wall 214. The height of the front wall 216 and the side wall 218 is selected in various examples to allow for receiving the single seed 202 into the cavity 212. The height is also selected such that the side wall 218 allows an inner singulator (as described in more detail below) to sweep into the cavity 212 and touch the seed 202 within the cavity 212 to perturb the seed 202 from a side opposite to the open end 222 (e.g., height defined based on a sweeping motion of the inner singulator). The lower height of the side wall 218 also allows a brush from a brush belt to brush the seed 202 out of the cavity as described in more detail herein (e.g., to brush the seed 202 off the metering member 200). It should be noted that the open end 222 is configured to allow an unobstructed exit of the seed 202 from the cavity 212. For example, the rear wall 214 forces the seed 202 into a brush of, for example a brush belt, as described in more detail herein, to “pull” the seed 202 out from the cavity 212, which is unobstructed as a result of the open end 222.

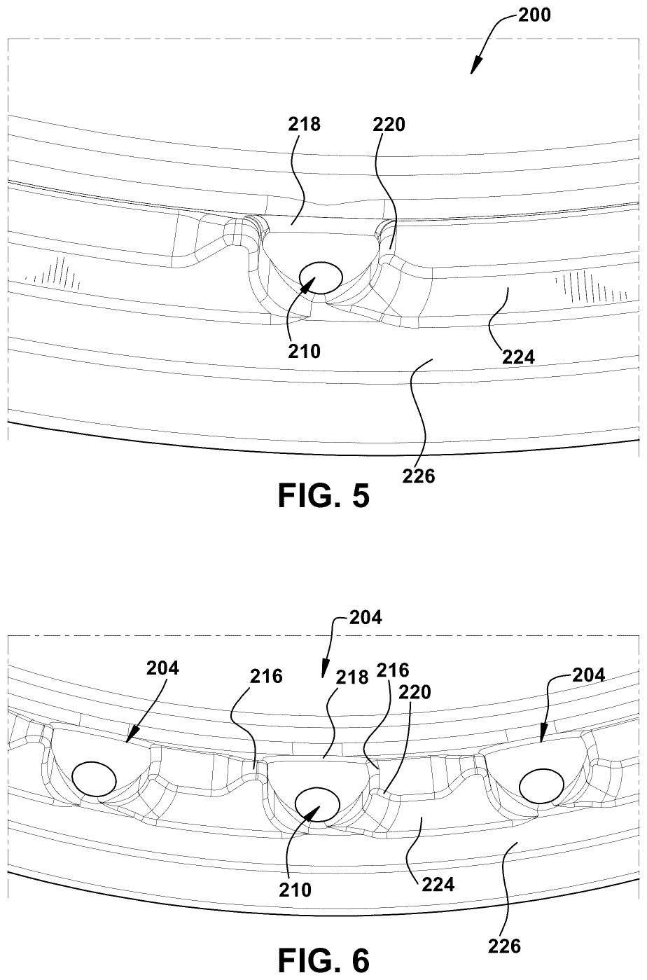

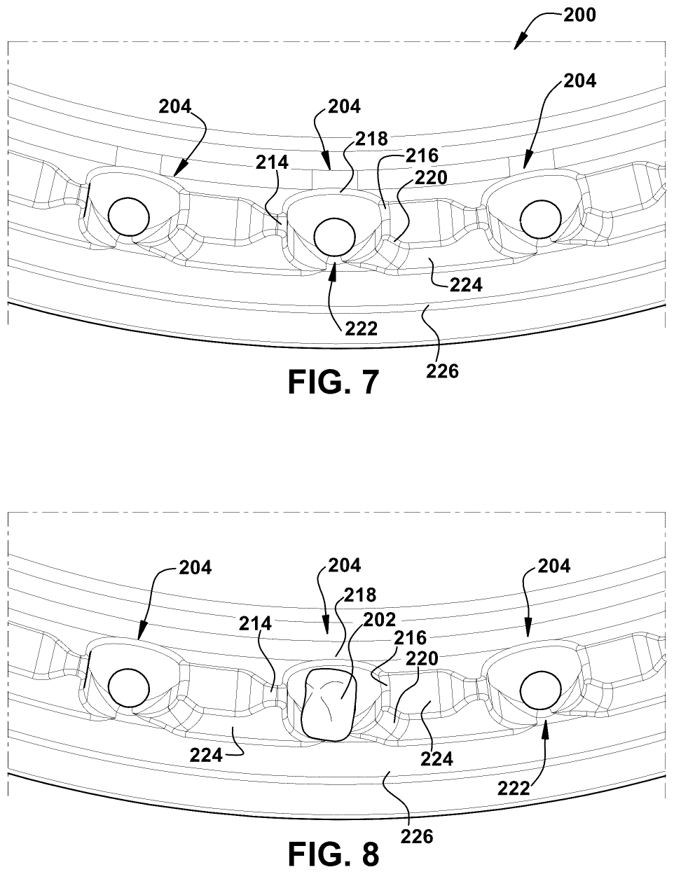

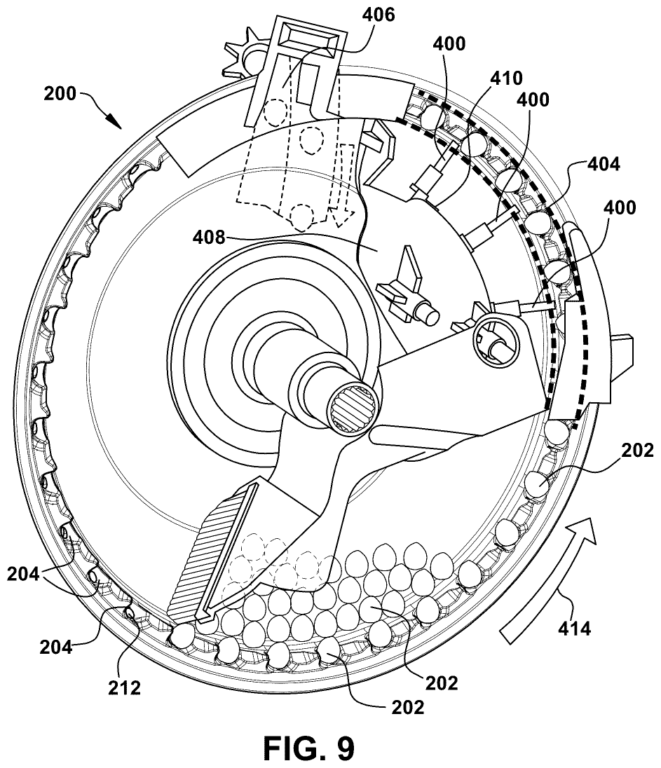

In some examples, such as shown in FIGS. 4-9, the seed receiving portions 204 include a chamfered edge 220 at a front outward end of the open end 222 (i.e., at the leading end of the seed receiving portion 204). That is, the chamfered edge 220 defines a slanted or angled inward wall portion at the front or leading edge of the seed receiving portion 204 that facilitates smoother entry of the seed 202 into the cavity 212, which includes allowing a resilient tine 400 (see FIG. 9) to flip into the cavity 212 and touch and perturb the seed 202 on an opposite side that the seed 202 is perturbed by the inner singulator. Additionally, the flipping of the resilient tine 400 into the cavity 212 facilitated by the chamfered edge 220 also removes any additional seed(s) 202 that may be in the cavity 212 to result in only one seed 202 within the cavity 212. The chamfered edge 220 can be differently shaped (e.g., angled), such as based on the type and/or size of the seed 202, the configuration of the tines 400, etc.

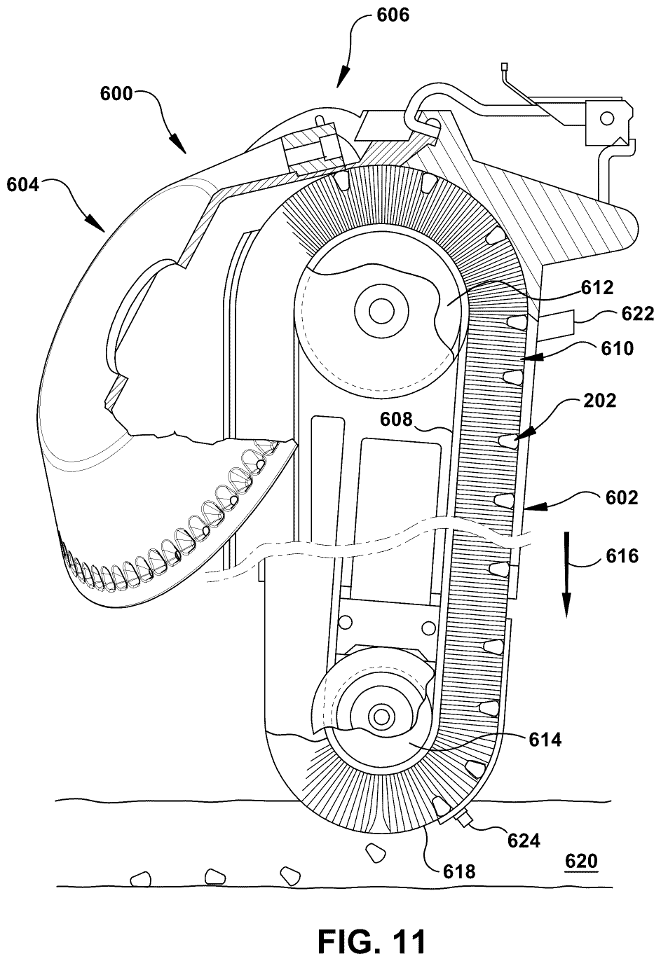

It should be noted that an outer wall 224 between the seed receiving portions 204 is separate from an edge 226 of the rim 206 at a distance to prevent the seeds 202 from being held within that area. That is, the lip formed between the outer wall 224 and the edge 226 of the rim 206 is sized and/or configured to prevent seed 202 from being lodged, wedged, or stuck along the lip (in-between the outer wall 224 and a wall of a housing 502 (shown in FIG. 11) of the metering member 200), and or prevent seeds 202 from escaping from the metering member 200. Additionally, the circumferential length of the outer wall 224 between cavities 212 is selected, for example, based on the type and/or configuration of the metering system or singulation system being used, the type and/or size of the seeds 202, etc.

Thus, the configuration of the cavity 212, including the walls 214, 216, 218 (forming raised structures along the rim 206 of the metering member 200), the chamfered edge 220 and the open end 222 facilitate singulation and delivery of the seeds 202. That is, the single open end 222 allows improved singulation access and later removal of the seed 202 from the cavity 212, the lower walls allow singulation access from the side opposite to the open end 22, the shape of the side wall 218 facilitates only one seed 202 within the cavity 212, the lower front wall 216 facilitate entry of the seed 202 into the cavity 212, and the higher rear wall 214 facilitates loading of the seed 202 into the brush. It should be noted that one or more of the herein described features and/or configurations can be combined to facilitate seed singulation and delivery.

With reference now to FIGS. 10 and 11 illustrating an example of a metering arrangement in which various examples can be implemented, with the rotation of the metering member 200, in the direction of rotation 414, the seeds 202 are caused to adhere to the cavities 212 by virtue of vacuum applied on the outer surface of a side wall 416, as the cavities 212 travel through a pool of seeds 202. The configuration of the metering member 200 as described herein facilitates loading of only one seed 202 into each cavity 212 (e.g., adhering a single seed 202 to each of the cavities 212).

The metering member 200 with the seed receiving portions 204 is configured to operate in combination with a plurality of resilient tines 400 to eliminate multiple seeds and ensure individual seeds to be moved to the delivery system from each of the cavities 212. It should be noted that the various examples described herein can be implemented in different types of systems, such as with different types of tines 400 (e.g., different arrangements and configurations of tines). The resilient tines 400 can be formed from different materials, such as polyurethane, nylon or rubberized material. The resilient tines 400 in some examples have a predefined profile, such as, an arcuate profile, flat profile, cylindrical profile or polygonal profile. Further, the resilient tines 400 have a predefined cross-section, such as, circular, polygonal or oval. The resilient tines 400 are radially spaced apart from adjacent resilient tines 400. The resilient tines 400 in combination with the seed receiving portions 204 are operable to eliminate multiples seeds from the cavities 212 under a wide range of vacuum applied. In some examples, the resilient tines 400 are also efficient in eliminating skips in the cavities 212. This means that when the vacuum is low, the resilient tines 400 operate in combination with the seed receiving portions 204 such that individual seeds in the cavities 212 are not dislodged. Thus, the resilient tines 400 operate in combination with the seed receiving portions 204 to maintain the coefficient of variation (COV), such that the seed spacing is accurately maintained for each crop type.

The metering member 200 carries the seeds 202 from a pool of seeds 202 along a seed path 404. In the illustrated example, the seed path 404 is circular. However, seed meters with different types of metering devices, e.g. a metering belt, may have a seed path with a combination of straight and arcuate segments. The seeds 202 are transferred to a release position 406 for being discharged to the delivery system. The resilient tines 400 are positioned before the release position 406. The resilient tines 400 in some examples comprise inner tines 400 and outer tines 400. The resilient tines 400 in one or more operative configurations extend towards the seed path 404. The resilient tines 400 are coupled with respect to a housing 502 by various known attachment techniques. The resilient tines 400 are optionally mounted on a sliding adjustable holder by mounting fixture 408 for adjusting the distance through which the resilient tines 400 extend towards the seed path 404 in some examples. The resilient tines 400 are configured to extend radially to the radially inner side of the seed path 404. The mounting fixture 408 is radially adjustable to move the tines 400 radially outwardly or inwardly to vary the aggressiveness of a double eliminator function in some examples.

The resilient tines 400 that are positioned radially outward of the seed path 404 are provided with predefined clearances via pockets 410 in the housing 502 to facilitate movement of the resilient tines 400 without interference. The resilient tines 400 have a fixed end and an operative free end. The free end of all the resilient tines 400 extend into the seed path 404 by the same distance in some examples. Alternatively, in other examples, the resilient tines 400 extend into the seed path 404 by the variable distances. The free end of the resilient tines 400 are configured so as to contact multiple seeds 202 carried in the seed receiving portions 204, with sufficient force so as to dislodge the multiple seeds from the seed path 404. However, the free end of the resilient tines 400 are configured not to contact the individual seeds 202 or to contact the individual seeds 202 with a force insufficient to dislodge the seeds 202 from the seed path 404. Thus, the resilient tines 400 in combination with the seed receiving portions 204 are configured not only to eliminate multiple seeds, but also to avoid skips.

Thus, in various examples, the metering member 200 is operable with different types of agricultural seeding machines, such as part of a seed meter 500 illustrated particularly in FIG. 11. The seed meter 500 includes the housing 502 and a cover 504. The housing 502 and the cover 504 are coupled to one another by complementary hinge features on the housing 502 and cover 504, respectively, in the illustrated example. The seed meter 500 is operated by motor via a drive spindle 506 coupled to the housing 502 in some examples. Alternatively, in other examples, mechanical or hydraulic drives may also be used for operating the motor. The seed meter 500 with the metering member 200 in various examples is configured to reduce the likelihood of or eliminate multiple seeds in each seed receiving portions 204 to prevent multiple seeds from being planted together.

FIG. 11 shows an example of a particular implementation of a seed metering system 600 and a seed delivery system 602, in which a metering member 604 (which can be configured or implemented as described in more detail herein, such as be embodied as the metering member 200) is positioned so that a seed discharge area 606 is above, and closely proximate to a seed delivery system 602. In various examples, the metering member 604 is configured to operate as a rotating member as described in more detail herein

In the illustrated example, the seed delivery system 602 includes a transport mechanism, which may be a continuous mechanism such as a belt 608, with a brush that is formed of distally extending bristles 610 attached to the belt 608 that act as a receiver for the seeds 202. The belt 608 is mounted about pulleys 612 and 614. The pulleys 612 and 614 are illustratively a drive pulley and an idler pulley. The drive pulley can be driven by a conveyance motor, such as an electric motor, a pneumatic motor, a hydraulic motor, etc. The belt 608 is driven generally in the direction indicated by arrow 616.

In operation, when seeds 202 are moved by the rotating metering member 604 to the seed discharge area 606, where the seeds 202 are discharged from the seed cells (e.g., seed receiving portions 204) in the rotating metering member 604, the seeds 202 are positioned within the bristles 610 by the projections (as described in more detail herein) that push the seed 202 into the bristles 610. The seed delivery system 602 in the illustrated example includes walls that form an enclosure around the bristles 610, so that, as the bristles 610 move in the direction indicated by the arrow 616, the seeds 202 are carried along with the bristles 610 from the seed discharge area 606 of the metering mechanism, to a discharge area 618 that may be above ground level, at ground level, or below ground level within a trench or furrow 620 that is generated by the furrow opener on the row unit 106 as described in more detail herein.

Additionally, a seed sensor 622 is coupled to the seed delivery system 602. As the seeds 202 are moved within the bristles 610, the sensor 622 is configured to detect the presence or absence of the seed 202. It should be noted that while the herein described examples are illustrated with the seed sensor 622, 122, in other examples, additional sensors can be used such as a seed sensor 624. In some examples, the seed sensor 622 is not provide and only the seed sensor 624 disposed at a different location is provided. Having the seed sensor closer to where the seed 202 is ejected from the system can reduce error in identifying the final seed location. Again, there can be multiple seed sensors, different kinds of seed sensors, and the seed sensors can be located at many different locations.

Also, in one example, the motor driving the belt 608, or the belt 608 itself, can be configured relative to a sensor that generates a signal indicative of the angular position of the motor or the belt 608. This signal can be used, along with the seed sensor signal and the speed of rotation of the belt 608 to determine when a sensed seed or seed grouping will arrive in the furrow 620.

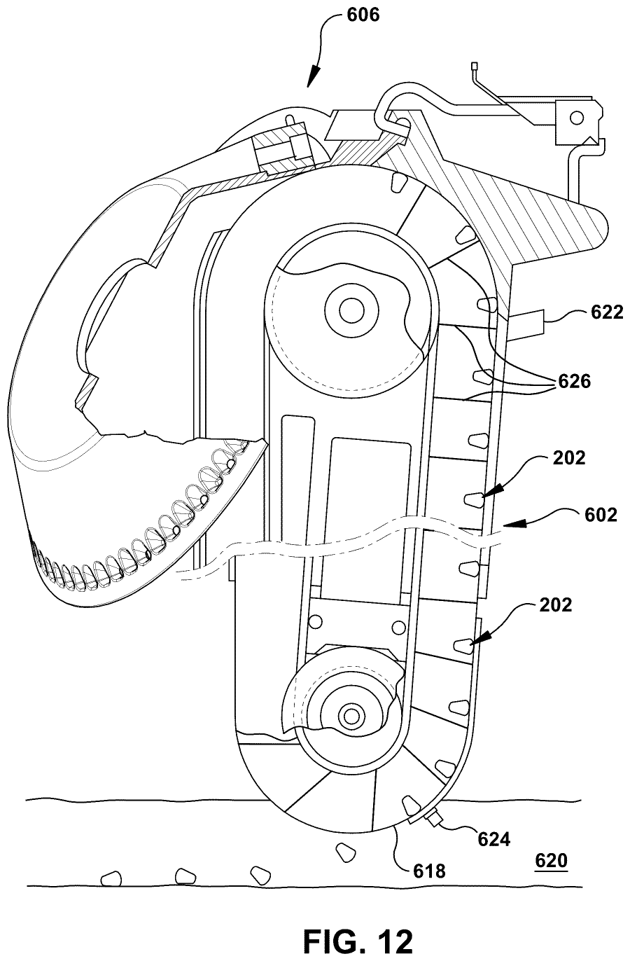

FIG. 12 is similar to FIG. 11, except that the seed delivery system 602 does not include a belt with distally extending bristles. Instead, the seed delivery system 602 includes a flighted belt (transport mechanism) in which a set of paddles 626 form individual chambers (or receivers), into which the seeds 202 are dropped, from the seed discharge area 606 of the metering mechanism. The flighted belt moves the seeds 202 from the seed discharge area 606 to the exit end of the flighted belt, within the trench or furrow 620.

It is contemplated that one or more examples are operable with other types of delivery system that include a transport mechanism and a receiver that receives the seed 202. For example, such systems include dual belt delivery systems in which opposing belts receive, hold, and move seeds 202 to the furrow 620, a rotatable wheel that has fingers or other objects, which catch seeds 202 from the metering system and move the seeds 202 to the furrow 620, multiple transport wheels that operate to transport the seed 202 to the furrow 620, and an auger, among others. As such, the herein described implementations are not limited to the endless member (such as a brush belt, a flighted belt) and/or a seed tube, but many other delivery systems are contemplated.

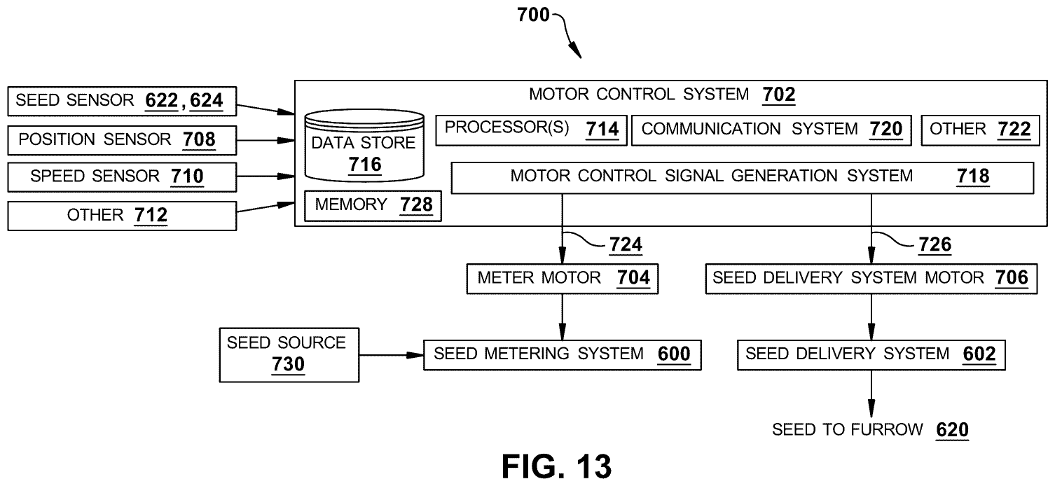

FIG. 13 is a block diagram of one example of a motor control architecture 700 in connection with which one or more examples can operate. The motor control architecture 700 includes a motor control system 702 that generates control signals for controlling a meter motor 704 and/or a seed delivery system motor 706. In the motor control architecture 700, the motors 704 and 704 drive, for example, the seed metering system 600 and the seed delivery system 602. The seed metering system 600 receives seeds from a seed source 730, singulates or meters the seeds 202, and provides the singulated or metered seeds 202 to seed delivery system 602. It should be noted the herein described examples are not limited to the seed delivery system 602 being an assistive delivery system, but the seed delivery system 602 can also be, for example a seed tube, in which case no seed delivery system motor is provided. It also should be noted that in some examples, the meter motor 704 and/or a seed delivery system motor 706 are configured as a smart motor. For example, the meter motor 704 in some examples is an integrated smart motor (ISM).

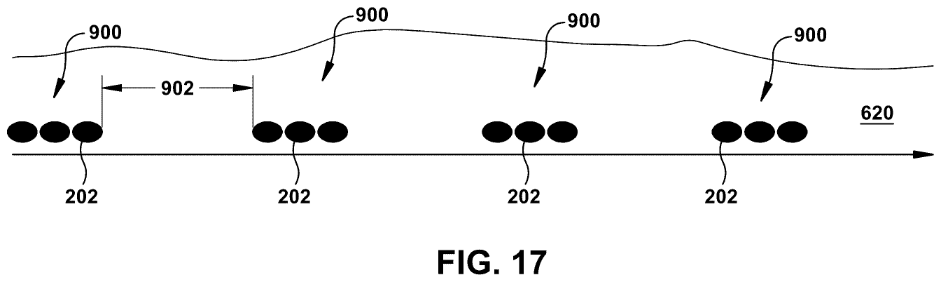

In some examples, the motor control system 702 generates motor control signals to control the motors 704 and/or 704 so that seeds 202 are delivered to the furrow 620 by the seed delivery system 602 as grouped or clustered seeds. For instance, the seeds 202 can be delivered in groups or clusters of two, three, four seeds 202 or more. The groups or clusters 900 are separated from one another by a group separation distance 902 as illustrated in FIG. 17, which show clusters of three seeds 202 in this example. It should be appreciated that in addition to the number of seeds 202 in the clusters 900, the distance between the clusters 900, namely the group separation distance 902, as well as other planting or seeding characteristics or properties can be varied as desired or needed. For example, the motor control system 702 can generate motor control signals to control the motors 704 and/or 704 to increase or decrease the group separation distance 902. In other examples, the motor control system 702 can generate motor control signals to control the motors 704 and/or 704 to generate a non-uniform spread pattern of the seeds 202 and/or the clusters 900. For example, the motor control system 702 can generate motor control signals to selectively and individually speed up or slow down the motors 704 and/or 704 (e.g., accelerate or decelerate the motors 704 and/or 704) to create any arbitrary pattern, grouping, and/or spacing of seeds 202.

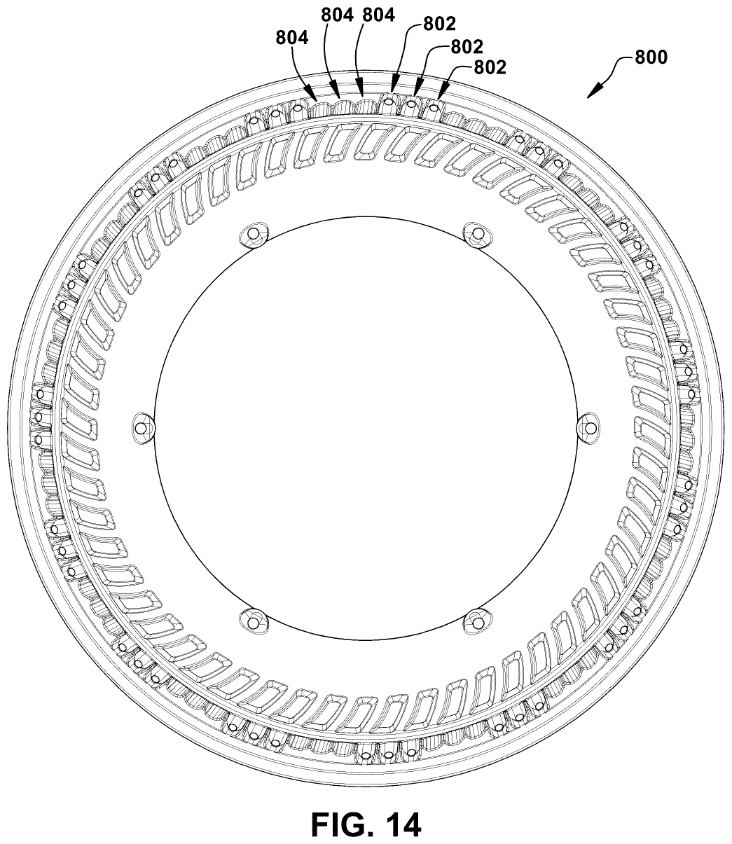

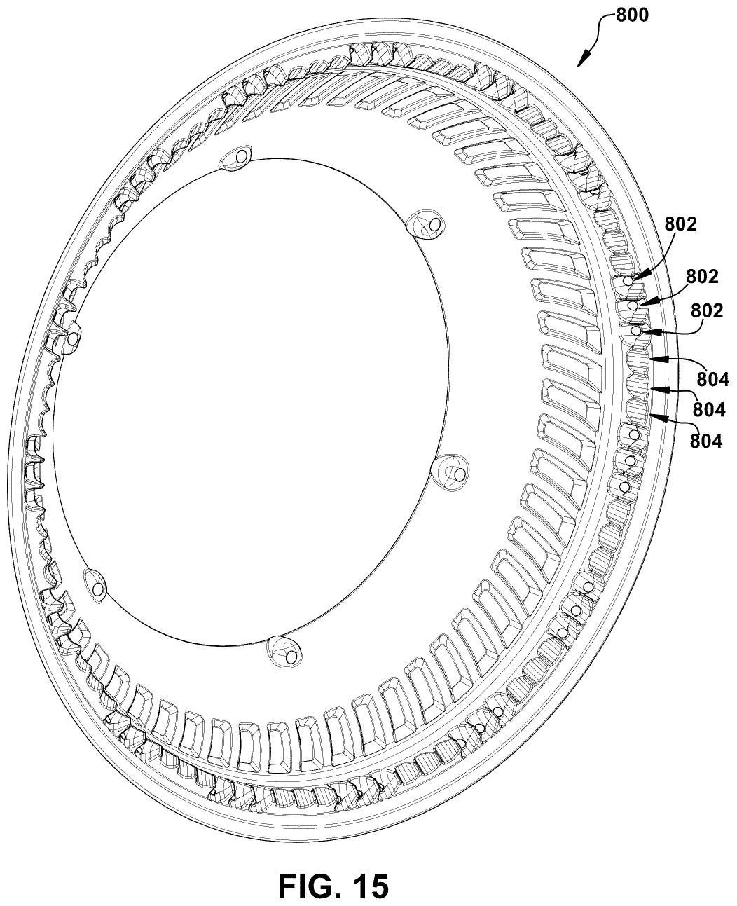

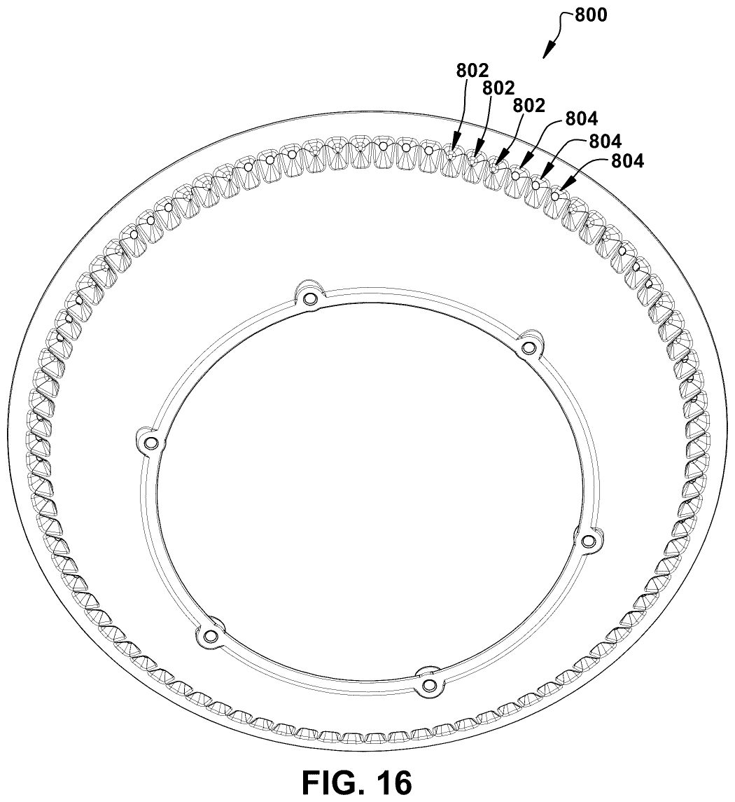

In various examples, the clusters 900 of seeds 202 define a hilldrop pattern wherein each hill includes a plurality of seeds 202. That is, the motor control system 702 generates motor control signals to control the motors 704 and/or 704 and in response clusters 900 of seeds 202 are planted as illustrated in FIG. 17. In one example, a metering member 800 as illustrated in FIGS. 14-17 is configured as a hybrid seed bowl that allows for hilldrop seeding that results in the clusters 900 of seeds 202, as well as singulation wherein drill down seeding is performed such that single seeds 202 are planted in a spaced apart pattern. For example, the motor control system 702 can generate motor control signals to control the motors 704 and/or 704 to increase a motor speed to form the seed hills with the clusters 900 of seeds 202 and then decrease the motor to speed to provide the group separation distance 902 using the metering member 800.

In this example as illustrated in FIG. 17, the furrow 620 is planted with a plurality of different groups or clusters 900 of seeds 202 separated by the group separation distance 902. As described herein, the separation distance, which separates the clusters 900, can be selected or controlled based on a wide variety of different criteria, such as crop type, hybrid, soil conditions, among a wide variety of other criteria. In the is example, the motor control system 702 generates motor control signals for controlling the meter motor 704 and/or seed delivery system motor 706 so that the desired number of seeds 202 are closely spaced relative to one another (such as within two centimeters of one another, etc.) in each cluster 900 (the intra-cluster seed spacing). The motors are also controlled so that the clusters are separated by one another by the desired group separation distance 902.

As another example, the motor control system 702 can generate motor control signals to control the motors 704 and/or 704 such that the speed of the motors is decreased to singulate the seeds 202 in a drill down planting configuration and then increase the speed of the motors during the formation of the group separation distance 902 to effectively perform single seed planting using the metering member 800. That is, in some examples, the metering member 800 having a hilldrop design is controlled to perform singulation wherein individual seed hills are provided by dropping the cluster 900 of seeds 202 using a slower motor speed and then performing a “twitching” operation in a twitch mode to increase the speed of the motors to effectively reduce the group separation distance 902. As such, single seed planting is performed such as illustrated in FIGS. 11 and 12 wherein a pattern of space apart single seeds 202 is provided. In this example, the metering member 800 is controlled such that clusters 900 of one seed 202 are provided.

Thus, motor control system 702 can receive an input from one or more seed sensors 622, 624, a position sensor 708, a speed sensor 710 and/or a wide variety of other detectors or sensor 712. In some examples, the position sensor 708 is a GPS receiver or another position sensor that identifies a geographic location of a row unit 104 (also referred to as a planting unit 104) in the field. Thus, if the seed clusters 900 are to be placed at pre-defined locations, the motor control system 702 is configured to control motors 704 and/or 706 to deposit seeds 202 in clusters 900 at the desired, pre-defined locations. In another example, there are no pre-defined locations, but the locations where the seeds 202 are actually deposited is captured by the motor control system 702 and sent to another system for mapping. In this example, the position identified by the position sensor 708, where the different clusters 900 are deposited, can be saved and forwarded to a mapping system or another suitable system.

Thus, in various examples, the speed sensor 622, 624 provide one or more speed signals indicative of a variety of different speeds. In one example, the speed sensor 622 or 624 senses the rotational speed of the motor 704 and/or motor 706, such as by sensing the speed of the output of the drive shaft of the motor, by sensing the speed of the rotatable element (such as rotatable element 200 or 800, or the continuous belt in the assistive seed delivery system 602, etc.). The speed sensor 622, 624 in some examples is a sensor configured to sense a speed indicative of the ground speed of the row unit 104. The speed signals are used to control the motors 704 and/or 706 to place the seed 202 or clusters 900 at the desired locations, or to map the locations where the seed 202 or clusters 900 are placed. Similarly, predictive calculations can be performed based on knowledge of future commanded operations. The predictive calculations can be used to control the motors 704 and/or 706 to place the seed 202 or clusters 900 at desired locations or to map the locations where the seed 202 or clusters 900 are placed.

In the example shown in FIG. 8, the motor control system 702 also includes one or more processors 714, a data store 716, a motor control signal generation system 718, a communication system 720, and can include a wide variety of other processing machines or systems 722. The communication system 720 enables communication among the various components in the architecture 700, and can enable communication with external systems (such as remote systems). For example, the communication system 720 can be configured to communicate over a controller area network (CAN) bus where a CAN bus is implemented. In some examples, the communication system 720 can be configured to communicate over a local area network, a wide area network, a near field communication network, a cellular communication network, or any of a wide variety of other networks or combinations of networks, where such communication is to be used.

In some examples, the motor control system 702 includes a memory 728. It should be noted that the memory 728 in some examples includes any computer-readable media. In one example, the memory 728 is used to store and access instructions configured to carry out the various operations disclosed herein. In some examples, the memory 728 includes computer storage media in the form of volatile and/or nonvolatile memory, removable or non-removable memory, data disks in virtual environments, or a combination thereof. In one example, the processor(s) 714 includes any quantity of processing units that read data from various entities, such as the memory 728. Specifically, the processor(s) 714 are programmed to execute computer-executable instructions for implementing aspects of the disclosure. In one example, the instructions are performed by the processor(s) 714 and the processor 714 is programmed to execute instructions such as those illustrated in the flowcharts discussed herein and depicted in the accompanying drawings.

It should also be noted that computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se.

The motor control signal generation system 718 in some examples obtains information, such as the target seed spacing or seed population (e.g., seed rate), a desired number of seeds per seed cluster or seed grouping, among other criteria. This information can be received through the communication system 720 based on an operator input. The motor control signal generation system 718 can obtain or receive the data from data store 716, or a remote data store, or the data can be received in other ways.

The motor control signal generation system 718 also receives inputs from one or more of the sensors described in more detail herein. Based on these signals, in some examples, the motor control signal generation system 718 generates a meter motor control signal 724, and/or a seed delivery system motor control signal 726. The signals 724 and 726 can be generated to pulse the operation of the motors 704 and/or 706 so that the seeds 202 are ejected by seed metering system 600 and/or seed delivery system 602 in clusters 900, as single seeds 202, independently of one another, or in correlation to one another. For example, when the motor control system 702 pulses the speed of the meter motor 704, the motor control system 702 can also pulse the speed of the seed delivery system motor 706. Alternatively, the motor control system 702 can pulse the speed of the meter motor 704 while maintaining the speed of the seed delivery system motor 706 relatively constant. These and other control mechanisms can be used to control the speeds of the motors 704 and 706 so that the seeds 202 are planted in seed groupings or clusters 900, separated by a desired group separation distance 902, or singulated and individually planted.

In one or more examples, the motor control system 702 is configured to control a hybrid seed bowl operation, such as controlling the metering member 800 (illustrated in FIGS. 14-16) designed for a hilldrop operation to also perform singulated operation. In various examples, the metering member 800 is similar to the metering member 800 without having equally spaced apart seed receiving portions 802. Instead, in the metering member 800, a set of seed receiving portions 802 are spaced apart from each other by cells 804 that are not capable of receiving seeds 202. That is, the cells 804 are “dummy” cells that do not have the openings, nor are shaped or sized, to receive the seed 202. As such, the cells 804 block seeds 202 from being positioned within the metering member 800 at the locations of the cells 804. Thus, spaced apart groupings or clusters of seed receiving portions 802. It should be noted while the metering member 800 is configured having three seed receiving portions 802 separated from another three metering member 800 by three cells 804, different numbers of seed receiving portions 802 and/or cells 804 can be provided. That is, the number of seed receiving portions 802 in each set can be equal or unequal. Similarly, the number of cells 804 can be equal or unequal. Or, the number of cells 804 between the seed receiving portions 802 can be greater or less than the number of seed receiving portions 802.

Thus, the metering member 800 illustrates another metering configuration that can meter commodity, such as the seeds 202 (e.g., corn). That is, the metering member 800 is configured as a hilldrop seed bowl to cluster the seeds 202 for dispensing, but that can also be controlled as described in more detail herein to provide singulated seed operation, such as with the agricultural seeding machine 100 described in more detail herein. It should be noted that the metering member 800 can be configured to operate with different types of metering and/or delivery system and can form part of differently configured metering devices. In some examples, the metering member 800 is configured as a bowl-shaped metering member. In other examples, the metering member 800 is configured as a disc-shaped metering member. In the various examples, the metering member 800 is generally configured having a cell-type geometry, such as for use with the ExactEmerge Seed Meter and Delivery Cartridge system available from John Deere.

The metering member 800 is, thus, generally operable as a rotatable mechanism that includes a rotatable disc or bowl similar to the metering member 200, except the metering member 800 has clustered seed receiving portions 802 (e.g., clustered apertures). In some examples, the seed receiving portions 802 within each cluster (illustrated as clusters of three), are spaced closely proximate one another. However, the clusters of seed receiving portions 802 are spaced from other clusters of seed receiving portions 802 about the periphery of rotatable element (or disc) by the cells 805 in various examples. It should be appreciated that any type or configuration of separation between the seed receiving portions 802 can be used. That is, in some examples, no cells 804 are provided between the seed receiving portions 802 and the seed receiving portions 802 are separated by an angle alpha. As such, in some examples, spaced apart seed receiving portions 802 are formed within the disc or bowl with the region or spacing between the seed receiving portions 802 having no cells. It should be noted that the value of the angle alpha can be varied as desired or needed, can be the same or different between adjacent sets of the seed receiving portions 802. For example, the angle alpha can be varied such that the plurality of seed receiving portions 802 configured as individual cells can be separated by different distances along a rim of the metering member 800. That is, the plurality of seed receiving portions 802 are spaced apart in clusters circumferentially along the rim. It should be noted that in some examples, the seed receiving portions 802 are configured similar to the seed receiving portions 204. However, in other examples, the seed receiving portions 802 can have a different configuration to allow receiving seeds 202 therein.

In various examples, as the metering member 800 rotates, a pressure differential is introduced into the interior of the metering mechanism so that the pressure differential influences seeds from the seed pool to be drawn into seed receiving portions 802. The seeds 202 are then rotated to a position where the seeds are removed from the seed receiving portions 802 (such as by a knockout wheel). In this way, during a hilldrop operation, the seeds 202 delivered by the seed receiving portions 802 into the seed delivery system are already clustered. However, as described herein, even with the clustered seed receiving portions 802, one or motors as described in more detail herein can still be “twitched” to place the seeds 202 in closer proximity to one another, or to increase the distance between clustered or grouped seeds 202, etc.

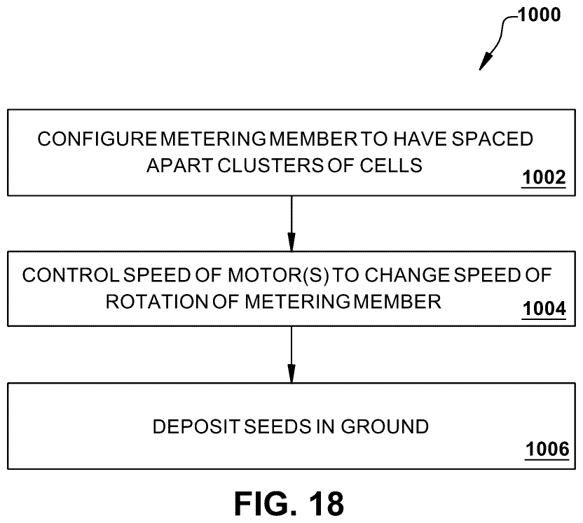

A metering arrangement is thereby provided and operates to meter seeds 202 in various examples. For example, the metering arrangement in some examples allows control of the metering member 200 or 800 to perform seeding operations. In one example, the metering member 800 configured for hilldrop seeding is controlled to perform singulated seeding as illustrated in the flowchart 1000 of FIG. 18. That is, the flowchart 1000 illustrates operations involved in seeding according to one implementation. In some examples, the operations of the flowchart 1000 are performed using the metering member 800 as described in more detail herein. The flowchart 1000 commences at operation 1002, which includes configuring a metering member to have spaced apart clusters of cells, such as the spaced apart seed receiving portions 802. That is, group or clusters of seed receiving portions 802 are space apart along a rim of the metering member 800 such that clusters of spaced apart seeds 202 are received by the metering member 800.

At operation 1004, one or more motors are controlled to change a speed of rotation of the metering member 800, such as during seeding operations. For example, the motors 704 and/or 706 are controlled to increase or decrease a speed thereof to cause the seeds 202 to be deposited in the ground in clusters in a hilldrop cluster configuration or as single seeds 202. That is, the motors 704 and/or 706 are controlled to allow for planting seeds in seed groupings or seed clusters, or individually. In some examples, the motor control signal generation system 718 obtains a target seed population that may be clustered seeds 202 or single seeds 202. The target seed population can identify the desired spacing between seed clusters or seed groupings, or a raw seed population per acre, among other things. The target seed population can define other seed population parameters and be received or obtained in various ways, and in some examples, determines whether the seeds 202 are deposited in the clusters 900 or as single seeds 202.

At operation 1006, seeds are then deposited in the ground as described in more detail herein. That is, the row unit 104 then begins the planting operation. During seed depositing with the metering member 800 is desired, the motor control signal generation system 718 intermittently pulses (speeds up and slows down) the motors 704 and/or 706, based upon the machine ground speed and target seed population, to plant the seeds in groupings or clusters separated by a desired group separation distance, or as individual seeds 202. In some examples, generating the motor control signals to pulse the motors 704 and/or 706 can include generating signals that cause the motors 704 and/or 706 to move faster during seed depositing when at locations of the metering member 800 that have seeds 202 (e.g., at the seed receiving portions 802), and then move slower in-between or at the gaps between the clustered arrangement of locations where the metering member 800 has seeds 202. As such, the metering member 800 is controlled to perform a hilldrop seeding operation to deposit seeds at 1006. In other examples, generating the motor control signals to pulse the motors 704 and/or 706 can include generating signals that cause the motors 704 and/or 706 to move slower during seed depositing when at locations of the metering member 800 that have seeds 202 (e.g., at the seed receiving portions 802), and then move faster in-between or at the gaps between the clustered arrangement of locations where the metering member 800 has seeds 202. As such, the metering member 800 is controlled to perform a single seeding operation to deposit seeds at 1006.

In various examples, drilled/hilldrop cotton planting is provided in which a single bowl design coupled with motor “twitching” can accomplish both planting methods without changing hardware. That is, hilldrop seeding, particularly a hilldrop cotton seeding capability and a drilled seeding, particularly a drilled cotton capability, are provided with a single set of hardware, such as the metering member 800 controlled as described in more detail herein. In various examples, one or more inputs can be received, such as from an operator or user, and can include, without limitation:
1. Whether or not to perform drilled or hilldrop cotton seeding.
2. The number of seeds 202 per hill.
3. The desired seed population.
4. The desired tightness of seed groupings (e.g., one inch to three inch spread from first to last seed of groupings).

In one or more examples, a drilled cotton bowl can be used and “twitched” such that groups of seeds (e.g., two, three, or four seeds) are sent down the speed-matching brush cartridge. In one or more examples, a hilldrop cotton bowl can be used and “twitched” such that groups of seeds (e.g., two, three, or four seeds) are sent down the speed-matching brush cartridge. In one or more examples, a hybrid cotton bowl can be used hilldropping (e.g., ninety-six hole-sites, with sixteen groups of three real holes alternating with 16 groups of three dummy holes to facilitate reliably controlling the bowl to twitch groups of three seeds into the cartridge. In some examples, a steady speed-matched brush speed is used so that the seeds 202 are always reliably speed-matched into the soil. The same bowl also can be used with controlled or tailored twitching to controllably determine the tightness of hilldrop groupings and the distance between sequential groups when performing hilldrop planting, as well as used for drilled cotton by twitching to accelerate through the dummy cells as described in more detail herein. With the hybrid single bowl configuration, one bowl can used for either drilled cotton or hilldrop, so that changing between bowl is not needed, such as when changes in soil-type or weather/ground conditions indicate when one bowl be used instead of the other, and vise-versa. In some examples, the switched operation can be performed in a prescription manner.

In some examples, the adaptation of seed singulation data can be used as follows:
1. % Singulation-->% Groups of =3 (or X) seeds
2. % Skips-->% Groups of <3 (or X) seeds
3. % Multiples-->% Groups of >3 (or X) seeds
4. Average seed spacing-->Average distance between groups
5. Coverage based on distance between groups (e.g., leading edge, trailing edge, or distance between centers can be used.)
6. Distance between seeds in a group not necessary
7. Distance between first and last seeds of a group would be helpful

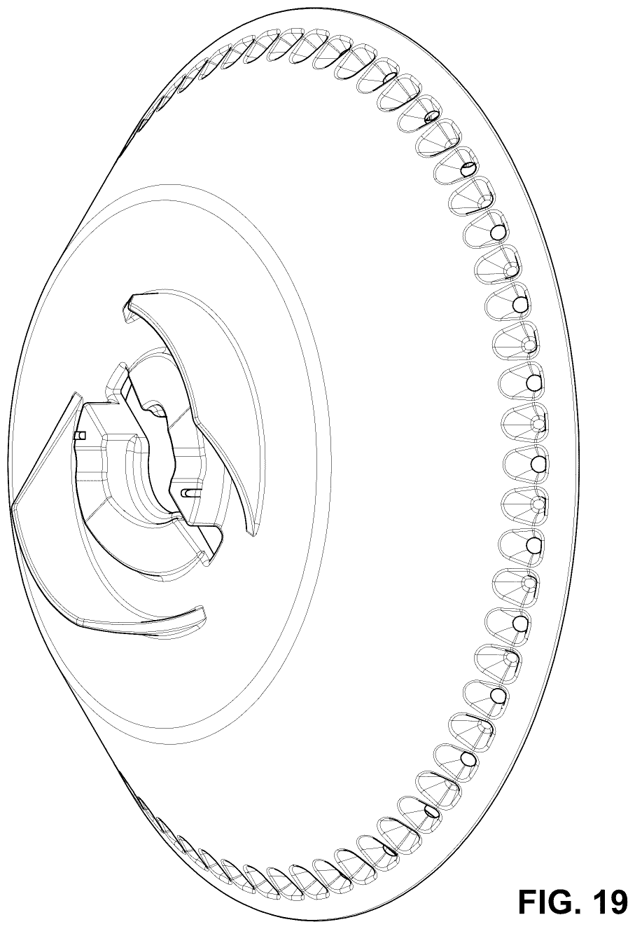

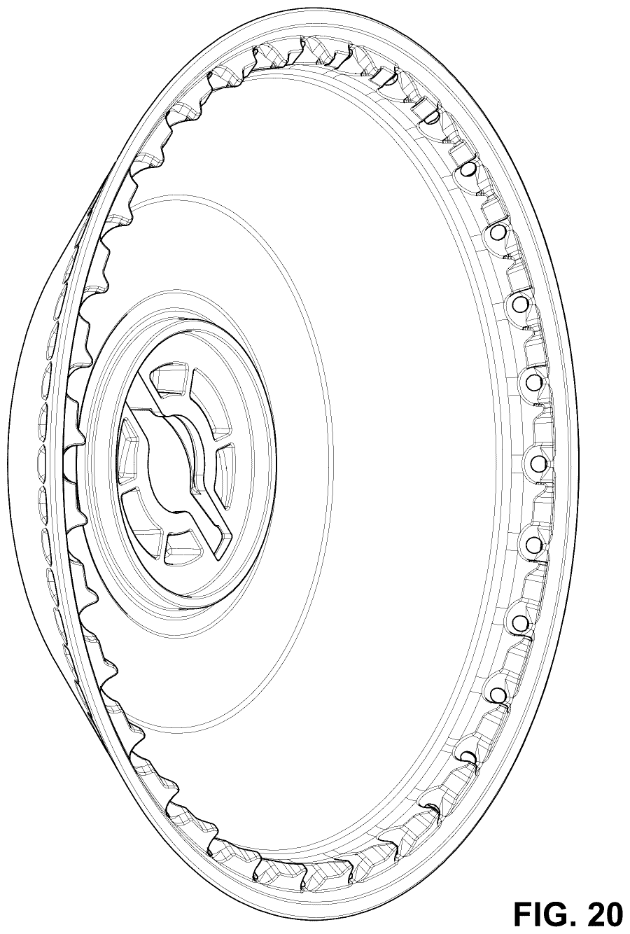

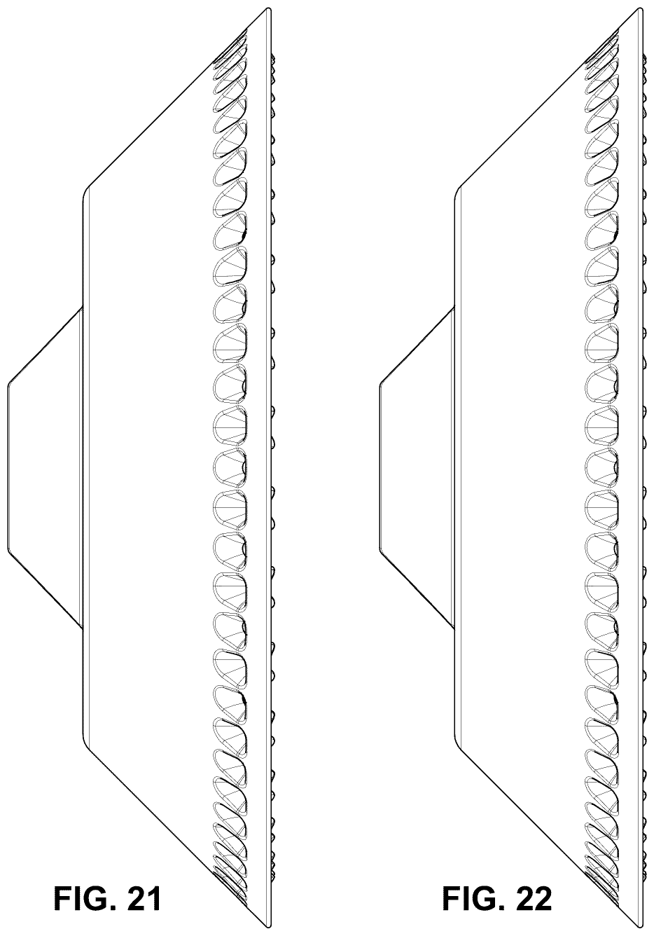

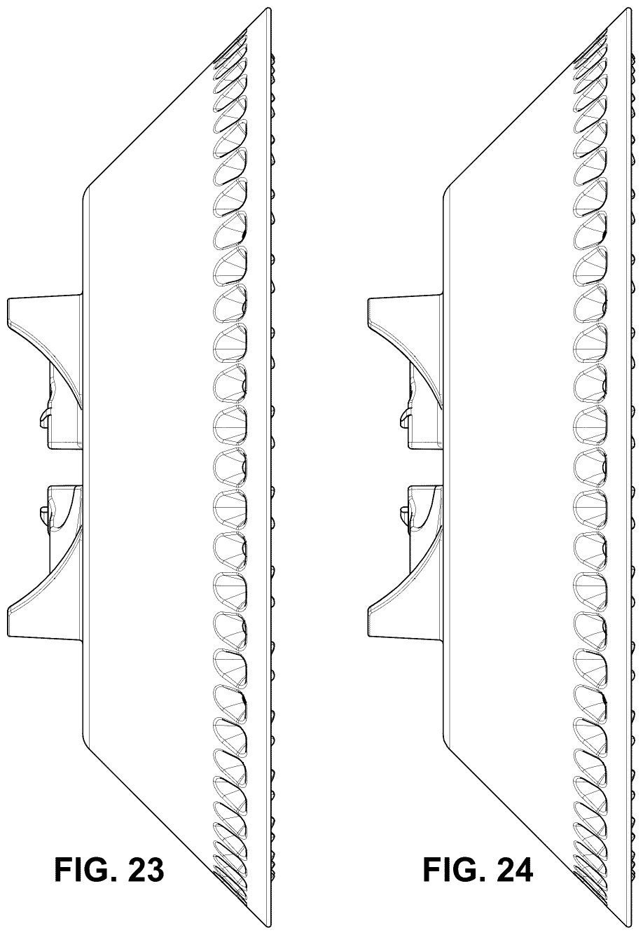

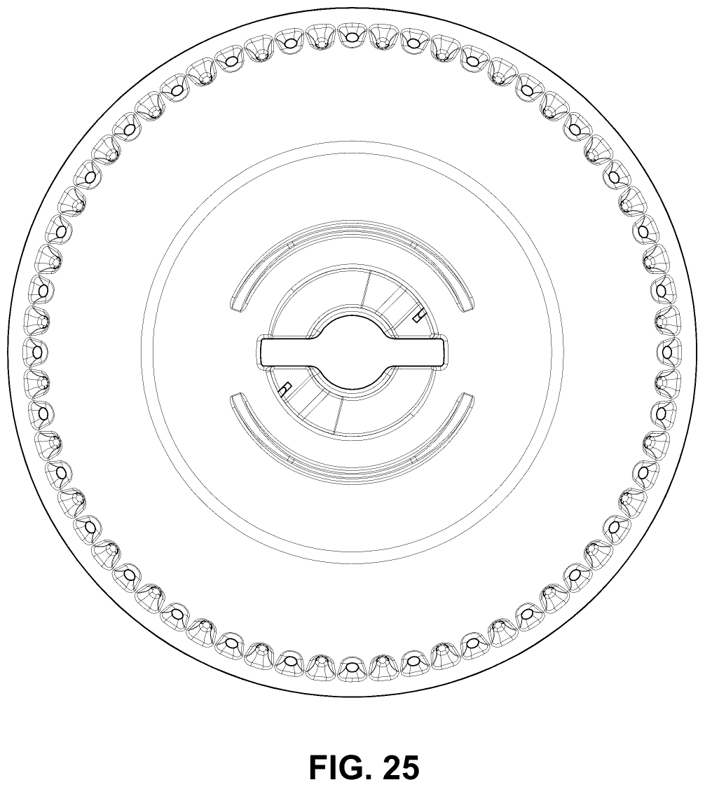

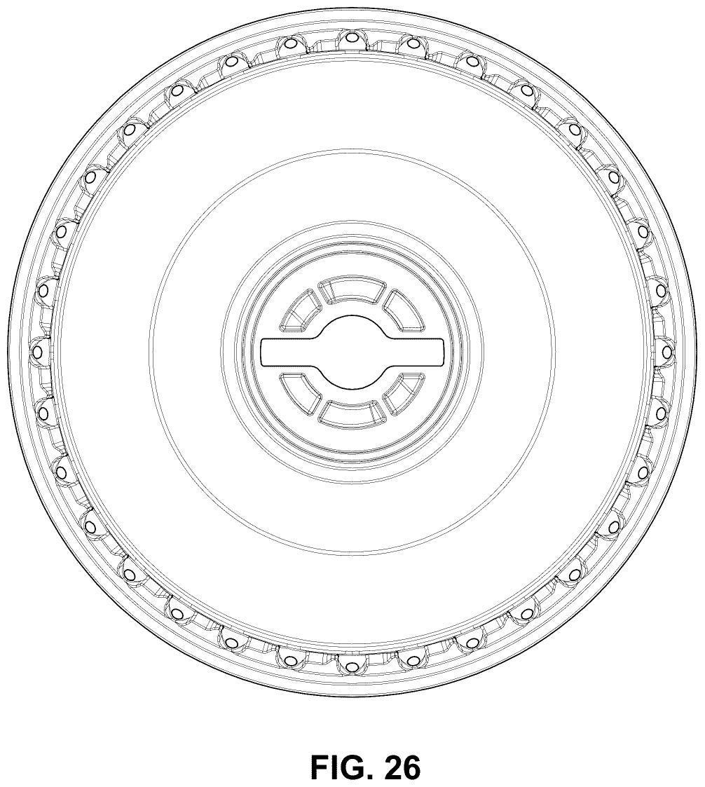

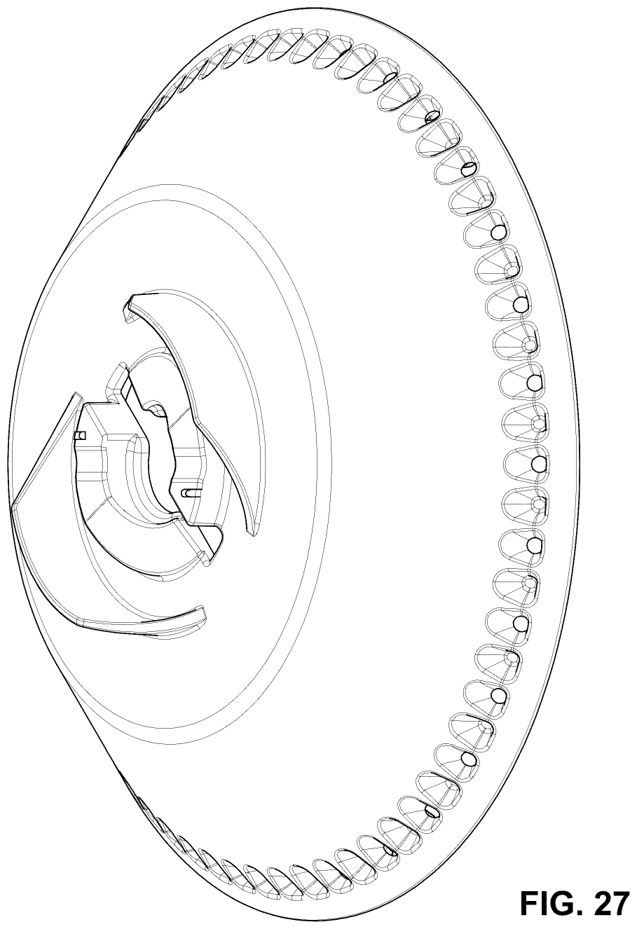

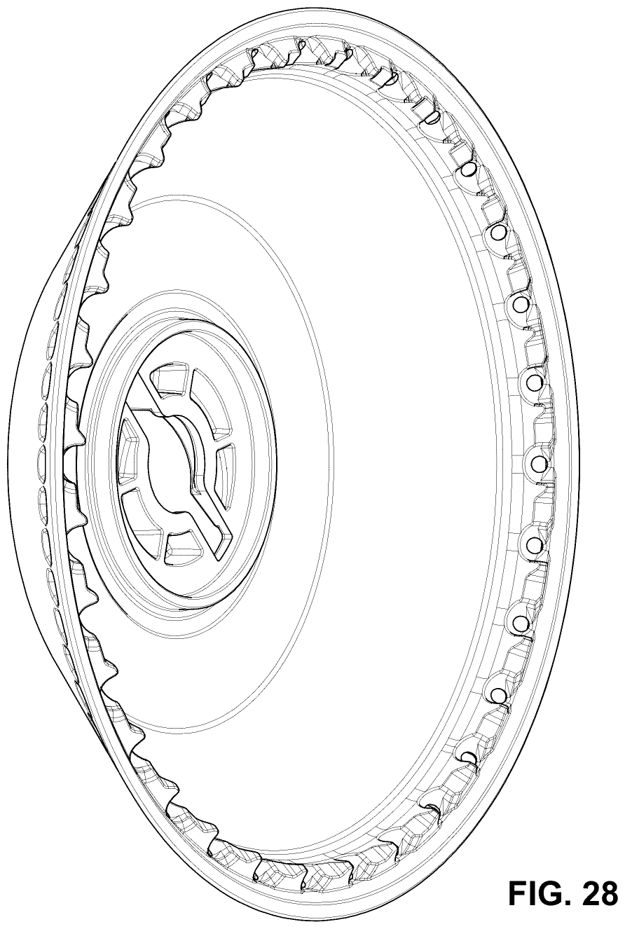

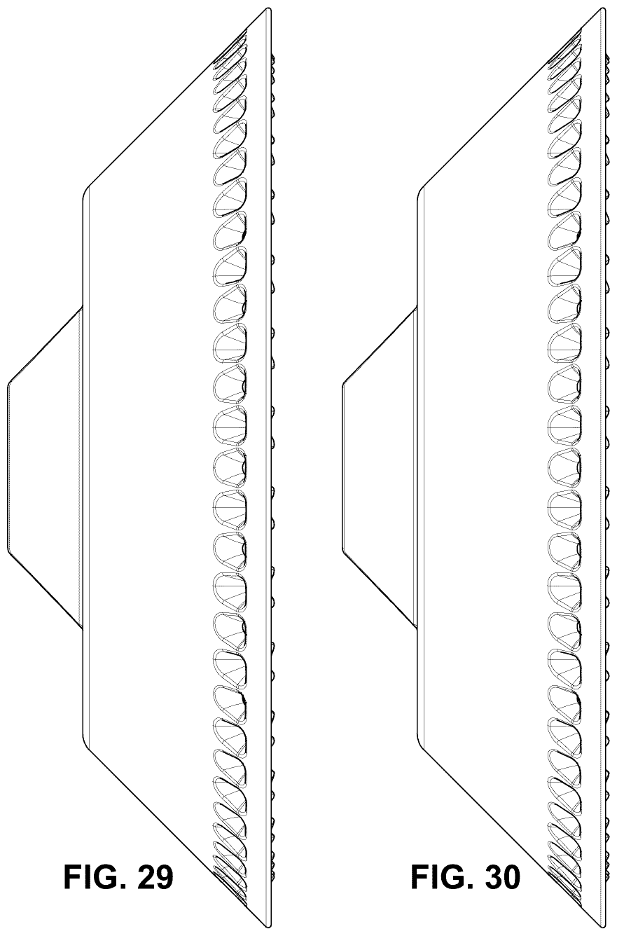

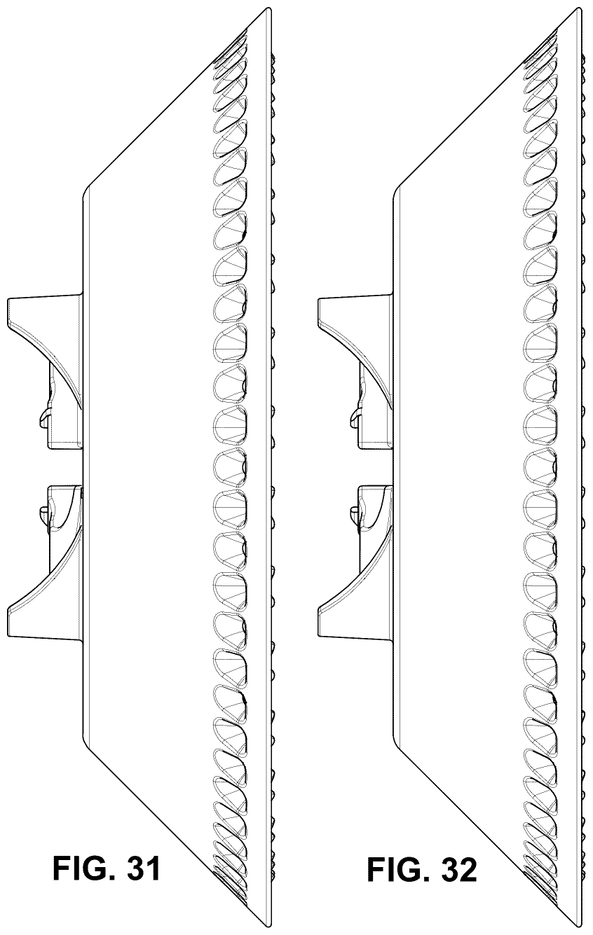

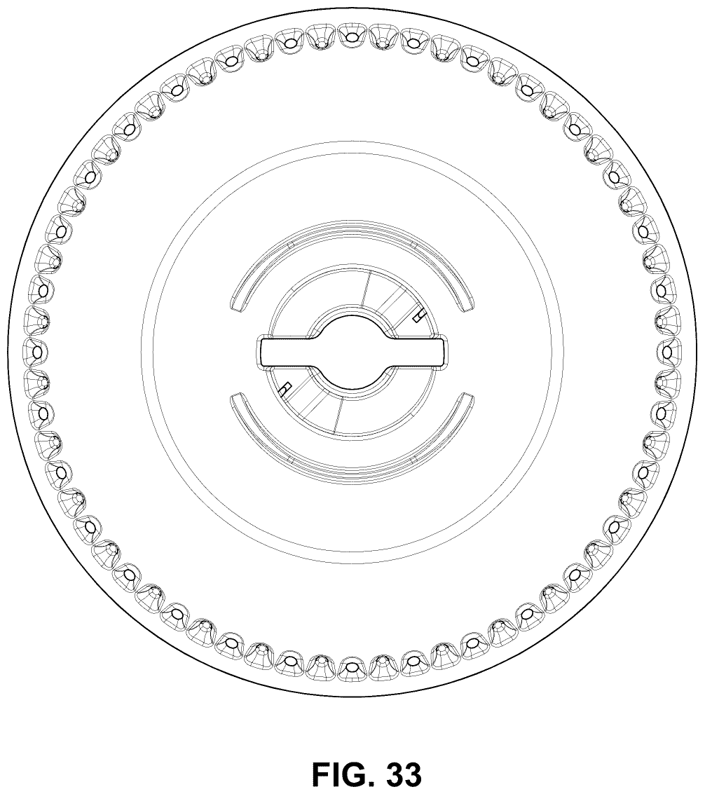

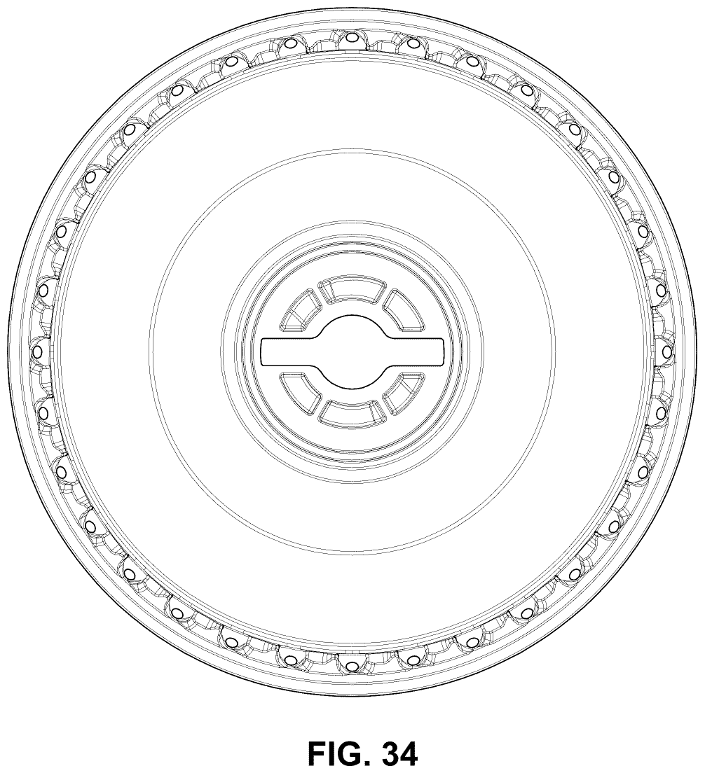

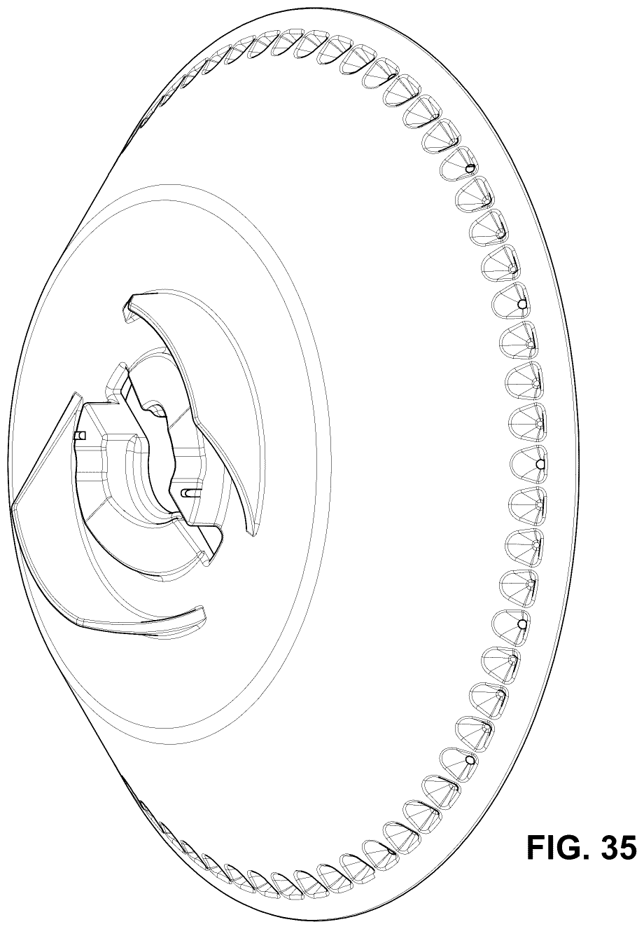

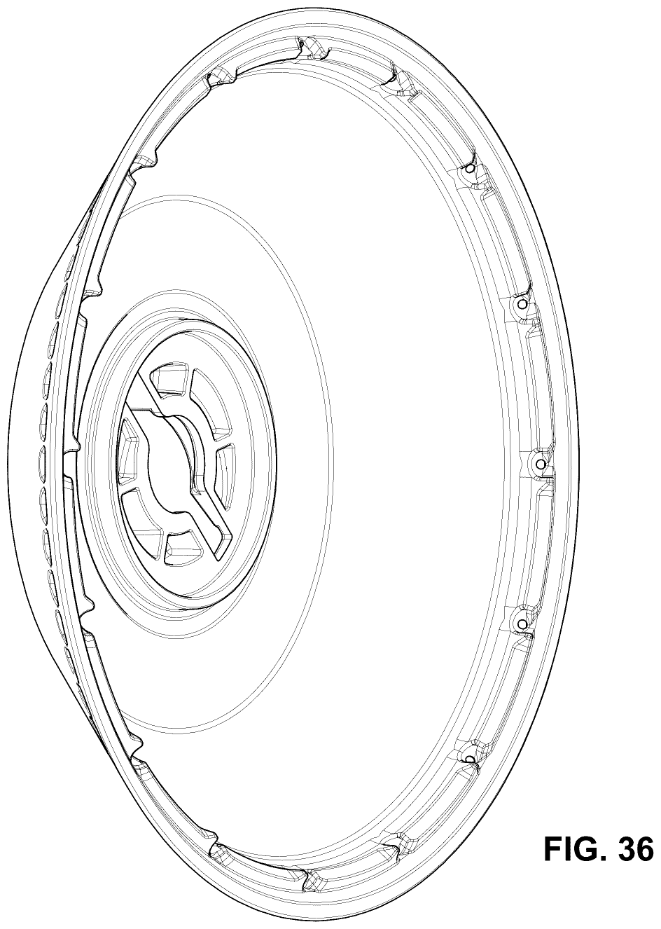

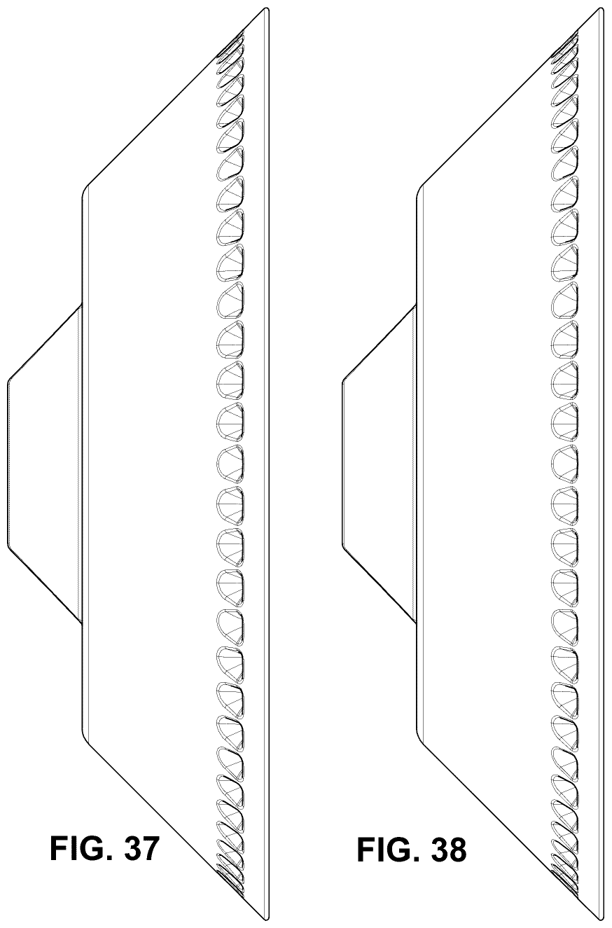

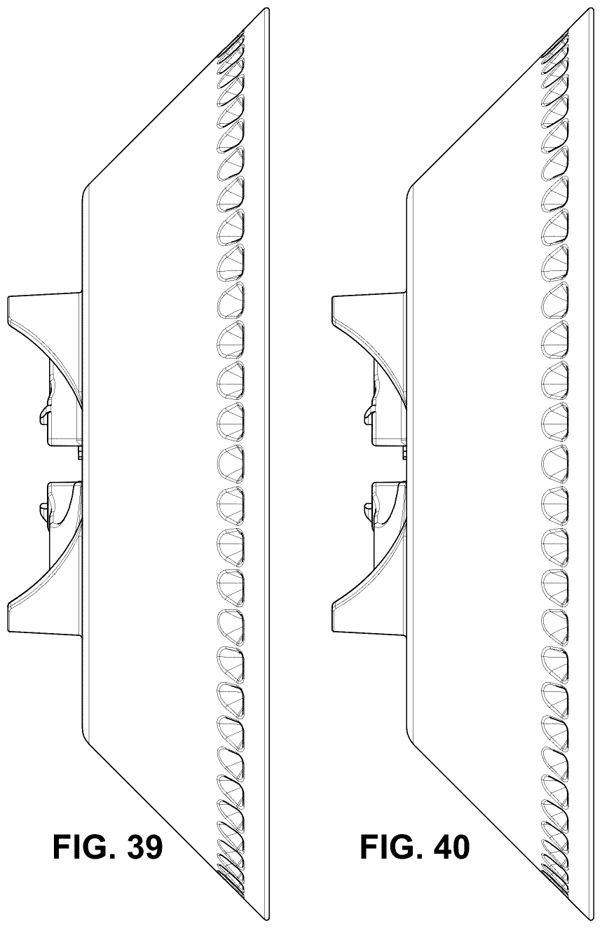

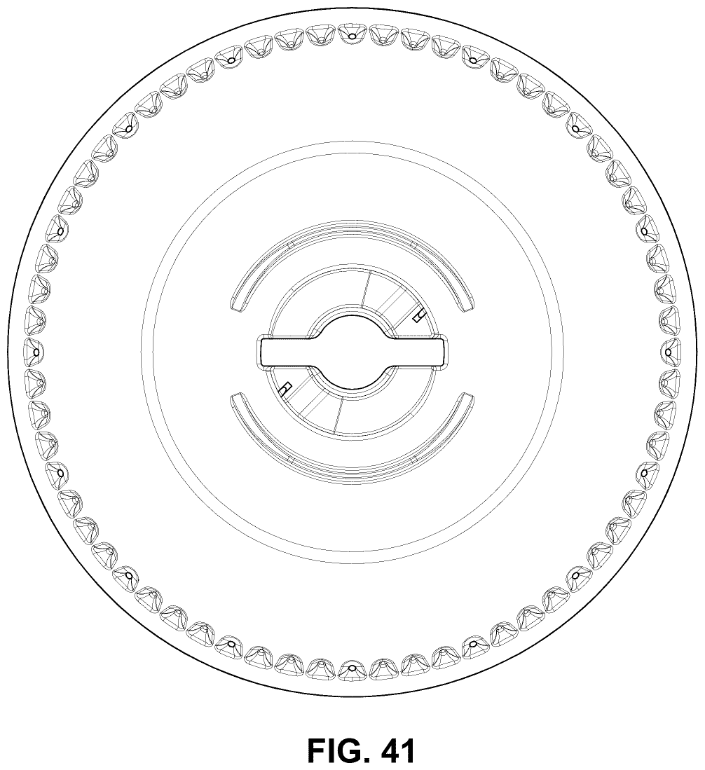

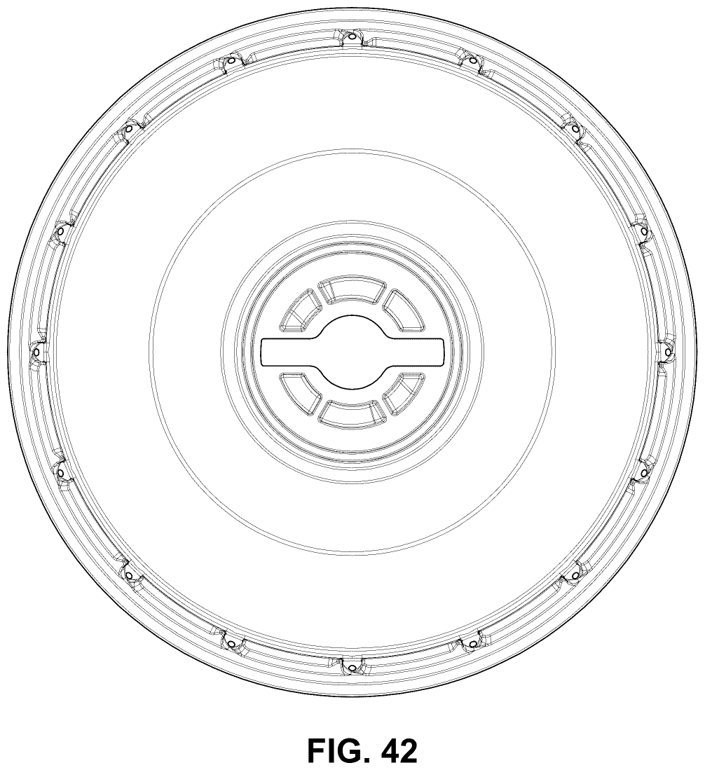

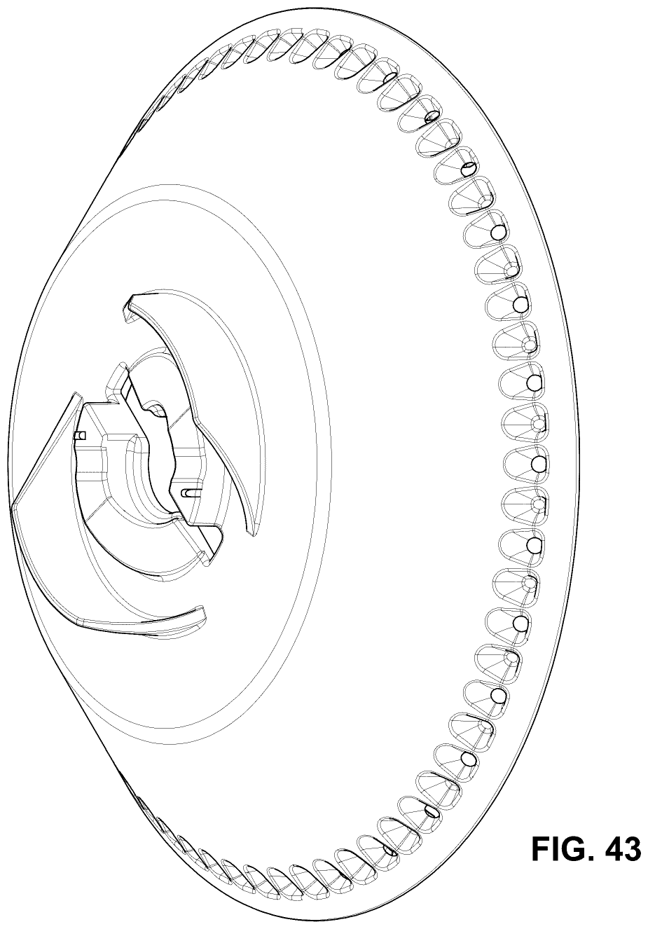

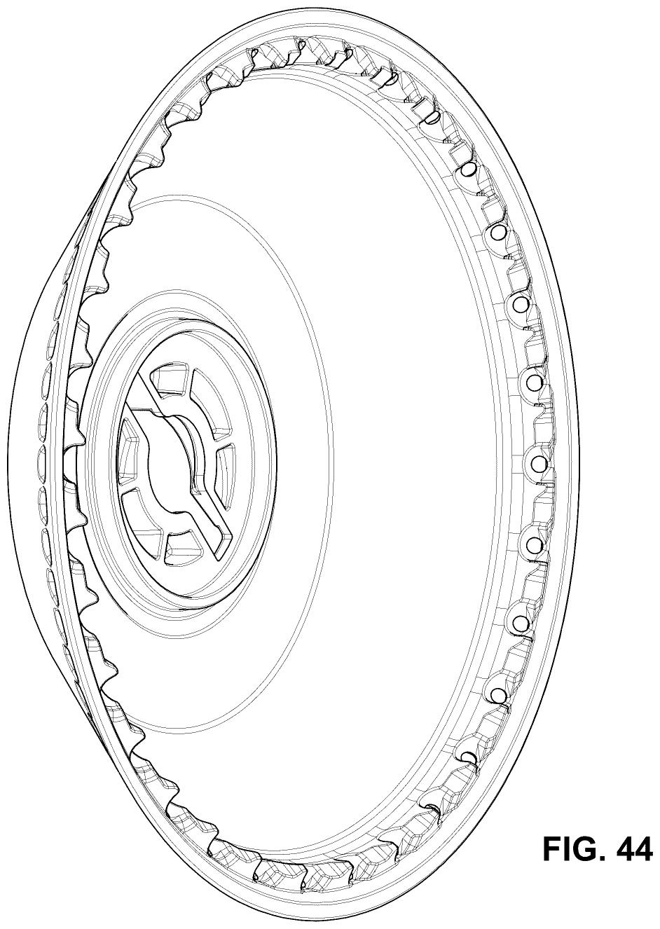

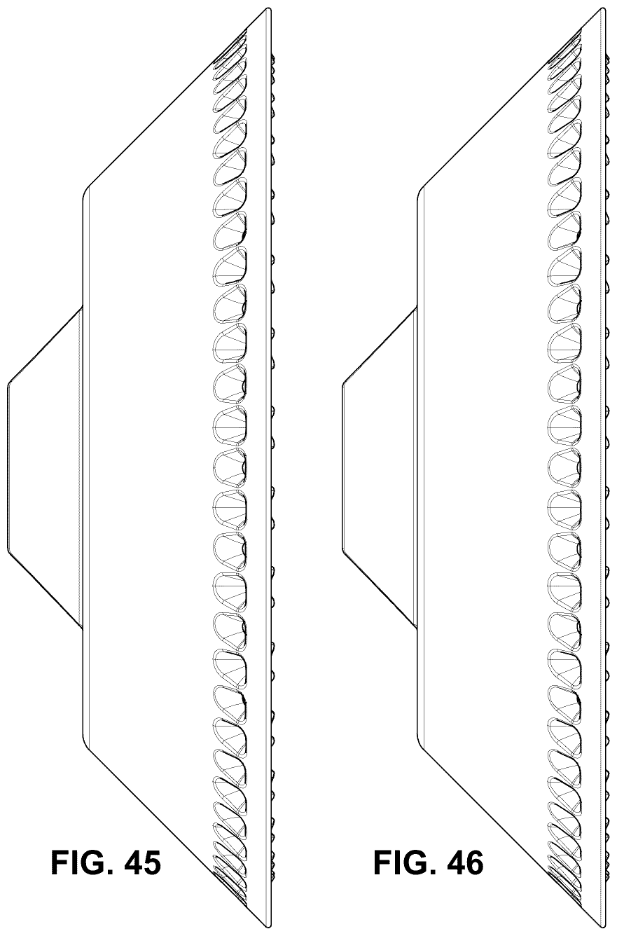

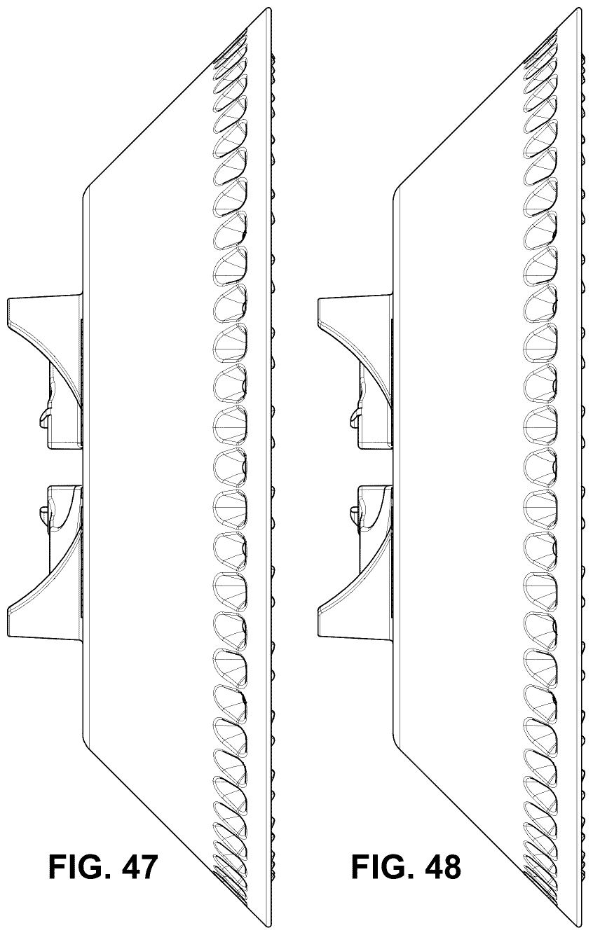

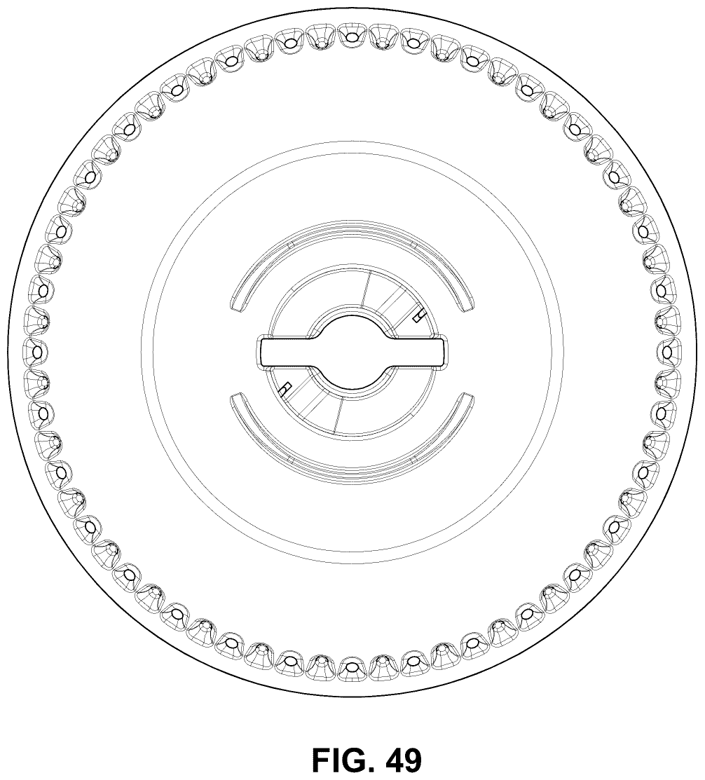

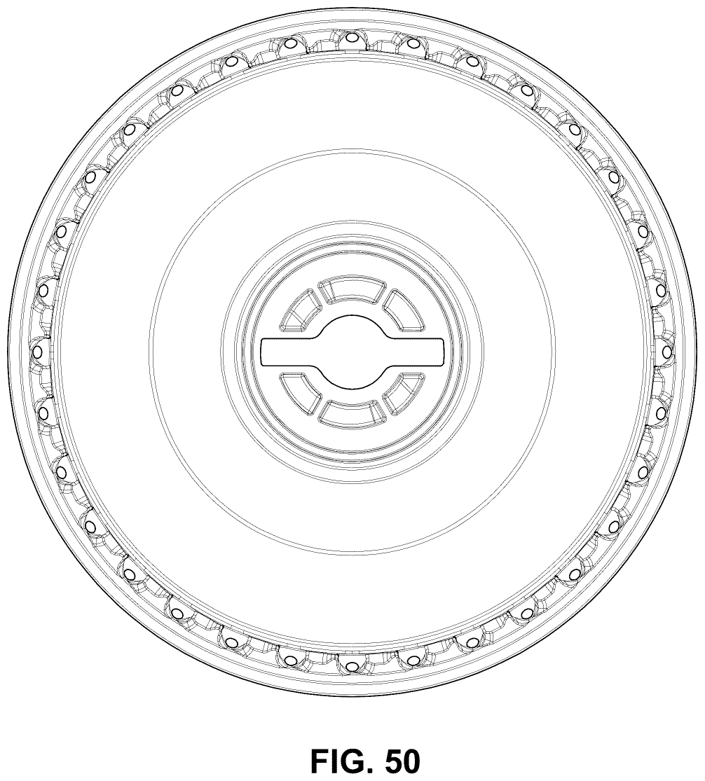

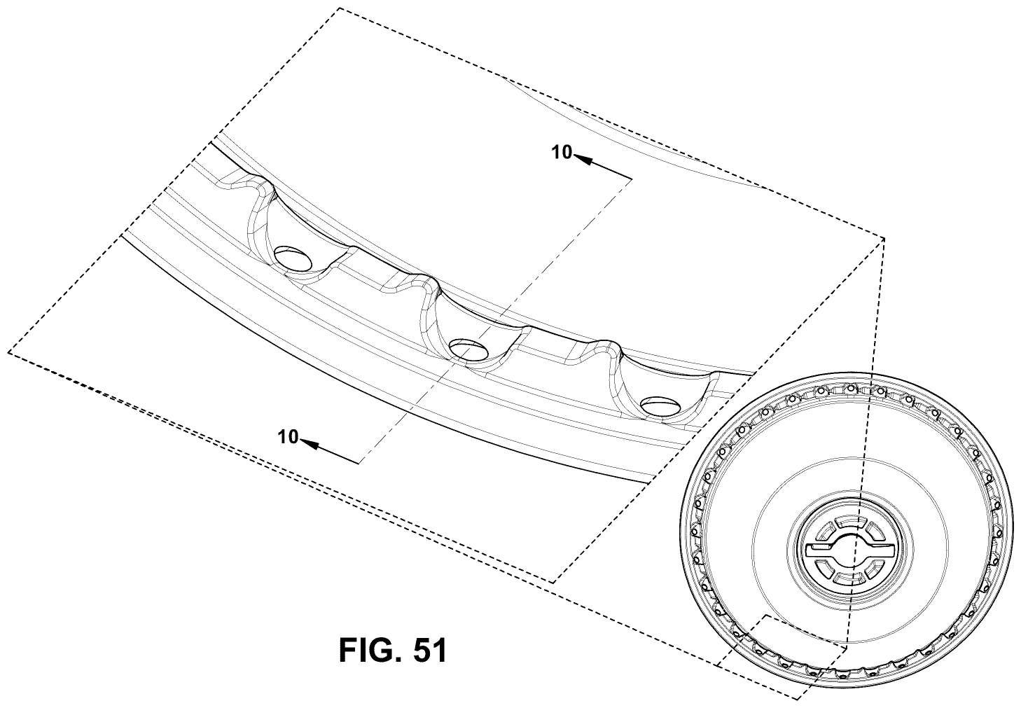

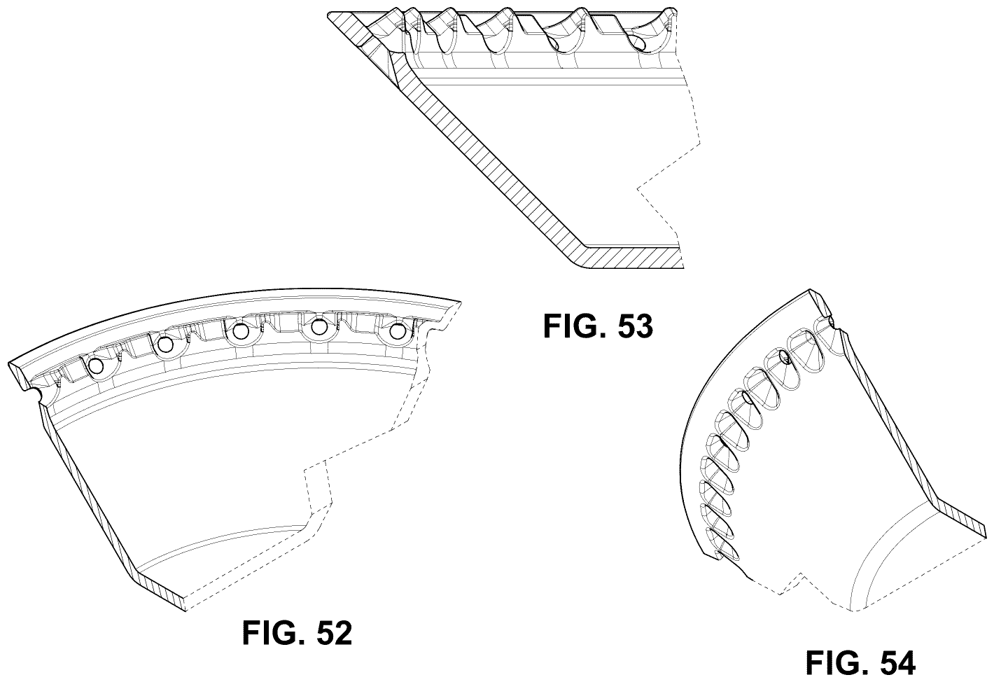

FIGS. 19-54 further illustrate various views of metering members according to various examples.

Thus, various examples provide improved singulation and seed metering. As described herein, the cell-type geometry increases the likelihood of proper singulation for subsequent planting of the seeds.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. A metering member for an agricultural implement, comprising:
a body configured to couple with a metering device; and
a raised ring formed circumferentially around a rim of the body, the raised ring defining a plurality of seed receiving portions each configured to receive a seed therein, the plurality of seed receiving portions having a plurality of walls defining a continuous wall structure and forming a cavity therein, wherein
the cavity has an outwardly facing open end, and
one or more walls of the plurality of walls have a different height than one or more other walls within each seed receiving portion.

2. The metering member of claim 1, wherein the plurality of walls comprises a rear wall, a front wall, and a side wall, wherein the rear wall is a trailing wall having a vertical height greater than a vertical height of each of the front wall and the side wall.

3. The metering member of claim 2, wherein the vertical height of the side wall is defined based on at least one of:
a configuration of an inner singulator, including a sweeping motion of the inner singulator,
a type of the seed, or
a size of the seed.

4. The metering member of claim 2, wherein the vertical height of the rear wall is defined based on a configuration of a seed brush, including a brushing motion of the seed brush configured to brush the seed out of the cavity.

5. The metering member of claim 1, wherein the plurality of walls comprises a side wall extending between a rear wall and a front wall, the side wall having an arcuate shape complementary to a shape of the seed.

6. The metering member of claim 1, wherein a size of the outwardly facing open end is defined based on a configuration of a tine, including a motion of the tine into the cavity.

7. The metering member of claim 1, wherein the plurality of walls comprises a front wall having a chamfered edge at a front outward end of the outwardly facing open end.

8. The metering member of claim 1, wherein the plurality of seed receiving portions define spaced apart cavities, wherein a distance between the spaced apart cavities is defined based on one of a type or size of the seed.

9. The metering member of claim 1, wherein the seed is one of a corn seed or a sunflower seed.

10. The metering member of claim 1, wherein the body comprises a disc.

11. The metering member of claim 1, wherein the body comprises a bowl.

12. The metering member of claim 1, wherein the raised ring comprises an outer wall spaced a distance from an edge of the rim, wherein the distance is defined based on one of a type or size of the seed.

13. A metering member for an agricultural implement, comprising:
a body configured to couple with a metering device; and
a plurality of protruding structures extending from the body, the plurality of protruding structures defining spaced apart seed-shaped cells therebetween and configured to receive seeds therein, wherein
each of the seed-shaped cells have a plurality of walls with different heights, and
at least one wall of the plurality of walls is an arcuate shaped wall having a configuration complementary to a seed shape.

14. The metering member of claim 13, wherein the plurality of walls form a continuous wall structure having a radially outwardly facing open end.

15. The metering member of claim 14, wherein the plurality of walls comprises a rear wall, a front wall, and a side wall, wherein the rear wall is a trailing wall having a vertical height greater than a vertical height of each of the front wall and the side wall.

16. The metering member of claim 15, wherein the front wall has a chamfered edge at a front outward end of the radially outwardly facing open end.

17. The metering member of claim 16, wherein the body comprises one of a disc or a bowl.

18. A system for planting seeds, comprising:
a metering member that receives seeds, at a seed meter input, from a seed source, and rotates to provide the seeds at a seed meter output;
a seed meter motor that drives rotation of the metering member;
a seed delivery system that receives the seeds, from the seed meter output, and outputs the seeds at an outlet end of the seed delivery system, into a furrow; and
a motor control system is configured to generate a motor control signal to control the seed meter motor to change a motor speed of the seed meter motor to selectively provide hilldrop seed groupings or singulated seeds.

19. The system of claim 18, wherein the metering member comprise a hilldrop configuration with spaced apart clusters of seed receiving portions, and the motor control system is further configured to operate in a twitch mode to increase a rotation speed of the metering member between the clusters of seed receiving portions to provide the singulated seeds.

20. The system of claim 18, wherein the motor control system is further configured to provide the hilldrop seed groupings for seed dropping operation and the singulated seeds for seed drilling operation.
